(19) United States
(12) Patent Application Publication
(10) Pub. No.: US 2026/0302693 A1
(43) Pub. Date: Oct. 1, 2026

(54) ELECTRICAL CONNECTOR APPARATUS AND METHOD

(71) Applicant: Samtec, Inc., New Albany, IN (US)

(72) Inventors: Jonathan Buck, Hershey, PA (US); Jose Luis Ortega, Irving, TX (US)

(21) Appl. No.: 19/107,687

(22) PCT Filed: Sep. 1, 2023
(86) PCT No.: PCT/US2023/031924

§ 371 Date: Feb. 28, 2025

Related U.S. Application Data
(60) Provisional application No. 63/403,561, filed on Sep. 2, 2022.
(60) Provisional application No. 63/481,702, filed on Jan. 26, 2023.
(60) Provisional application No. 63/511,451, filed on Jun. 30, 2023.

(51) Int. Cl. H01R 13/6461; H01R 12/71; H01R 12/75; H01R 13/24; H01R 13/627; H01R 13/6585

(52) U.S. Cl. CPC H01R 13/6461; H01R 12/716; H01R 12/75; H01R 13/2485; H01R 13/2492; H01R 13/6271; H01R 13/6585

(57) ABSTRACT

An electrical connector apparatus and method as described herein. The electrical connector may include a plug connector. The electrical connector may include a mating interface. The mating interface may include a plurality of plates. The electrical connector may include a substrate. The electrical connector may include a cable connector. The electrical connector may have at least a density of at least 213 differential pairs per square inch, including 256 differential pairs per square inch. The electrical connector may include at least one internal and/or external locking mechanism.

### CROSS-REFERENCE TO PREVIOUS APPLICATIONS

This application claims priority from U.S. provisional patent application No. 63/403,561 filed on Sep. 2, 2022, U.S. provisional patent application No. 63/481,702 filed on Jan. 26, 2023, and U.S. provisional patent application No. 63/511,451 filed on Jun. 30, 2023, the entire contents of which are hereby incorporated herein by reference in its entirety.

### TECHNICAL FIELD

The present embodiments relate generally to an electrical connector apparatus/assembly, with particular embodiments shown for an electrical connector.

### BACKGROUND

Typical connectors intended to operate at 112G/224G may require a larger width of the die package substrate to accommodate. However, this practice of increasing the size of the die package substrate may increase insertion loss and/or make the die package substrate more susceptible to curling, warping, and/or losing coplanarity during reflow. Thus, there is a need to improve the die package substrate size, reduce the width of the connector, minimize coplanarity issues, and/or minimize insertion loss.

The present invention is directed at overcoming, or at least improving upon, the disadvantages of the prior art.

### BRIEF DESCRIPTION OF OTHER TECHNICAL FEATURES

U.S. Pat. Nos. 7,927,144; 3,587,028; 11,539,169; 4,571,014; 4,720,770; 6,435,913; 6,506,076; 6,981,898; and 4,632,476 and US Publication Nos. US20200212631; US20200280145; US20220368084; US20090203259; US20050215120; and US20210265785 are hereby incorporated by reference in their entireties.

### BRIEF DESCRIPTION OF THE ILLUSTRATIONS

In the drawings, like reference characters generally refer to the same parts throughout the different views. Also, the drawings are not necessarily to scale, emphasis instead generally being placed upon illustrating the principles of the invention.

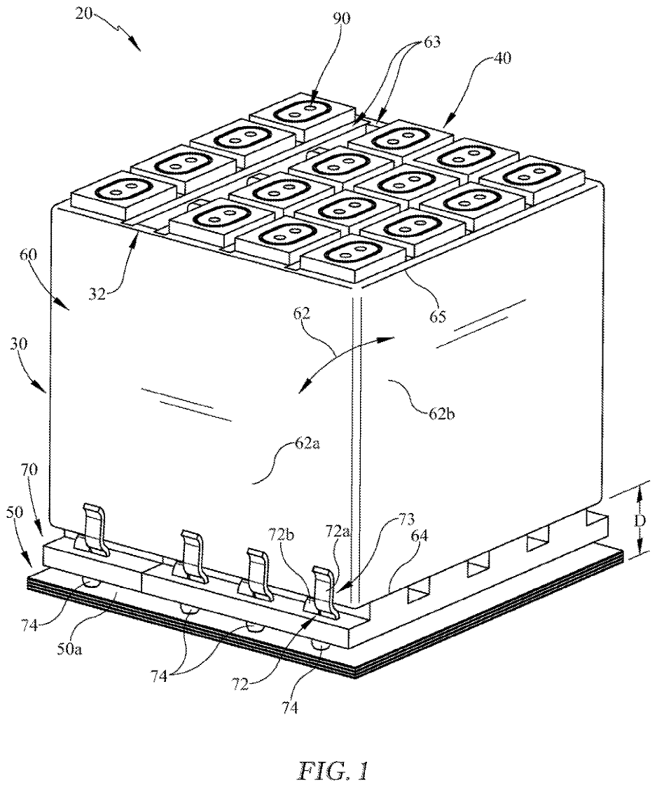

FIG. 1 is a perspective view of one embodiment of an electrical connector assembly illustrating one embodiment of an electrical connector.

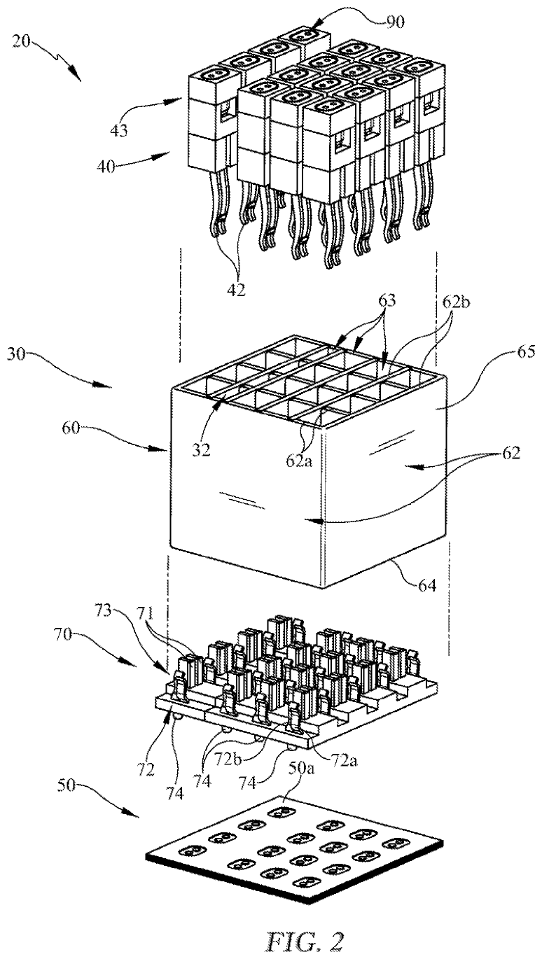

FIG. 2 is an exploded view of the electrical connector assembly of FIG. 1.

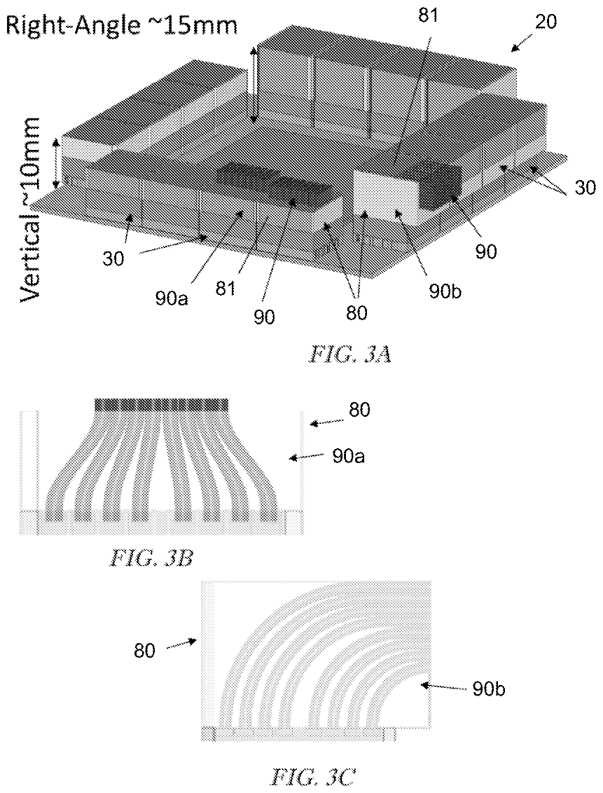

FIG. 3A is a perspective view of a plurality of electrical connectors of FIG. 1.

FIG. 3B is a side view of a vertical cable of FIG. 3A.

FIG. 3C is a side view of a right-angle cable of FIG. 3A.

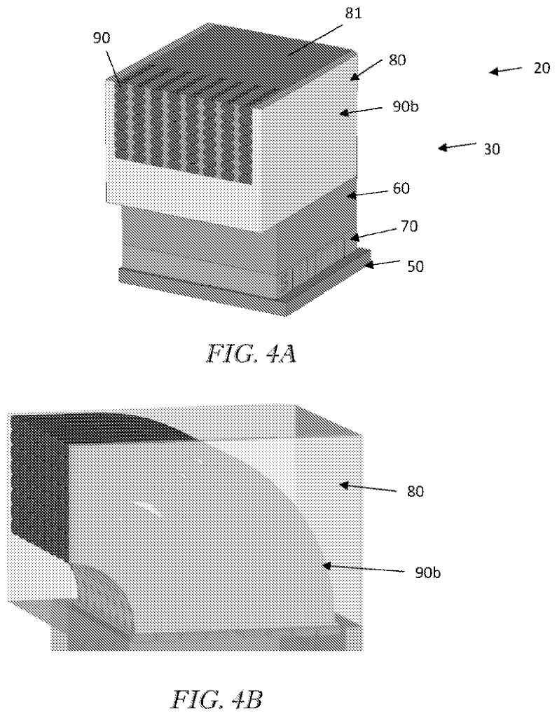

FIG. 4A is a perspective view of the right-angle cable and electrical connector of FIG. 3A.

FIG. 4B is a perspective view of the right-angle cable of FIG. 4A.

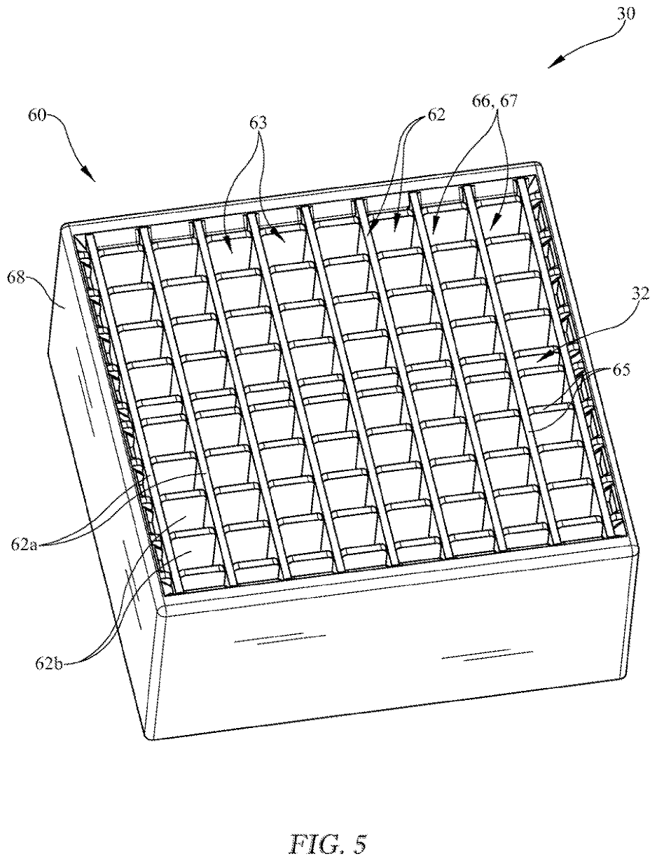

FIG. 5 is a perspective view of an embodiment of the mating interface of the electrical connector of FIG. 1.

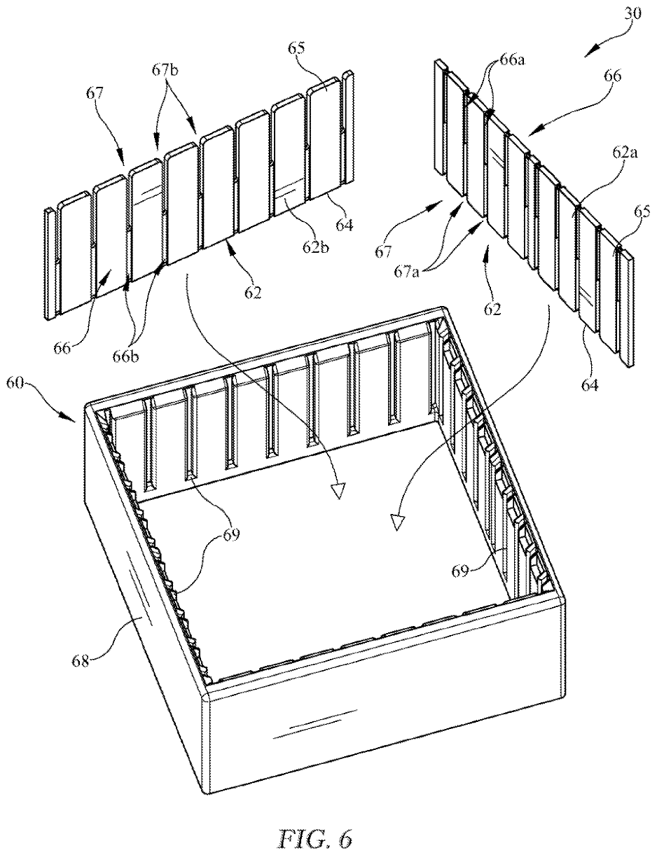

FIG. 6 is an exploded view of the mating interface of FIG. 5.

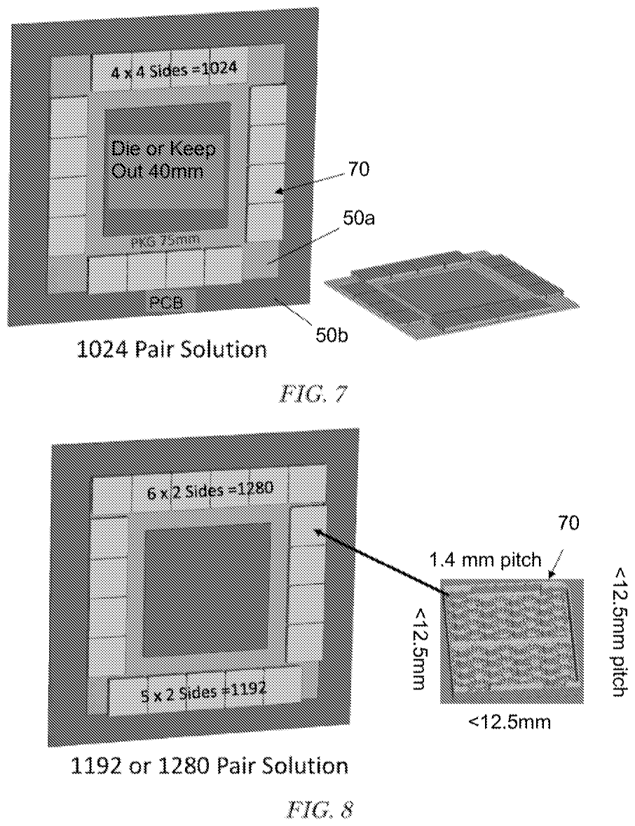

FIG. 7 is a perspective view of the electrical connector assembly illustrating 1024 pairs.

FIG. 8 is a perspective view of the electrical connector assembly illustrating 1192 and/or 1280 pairs.

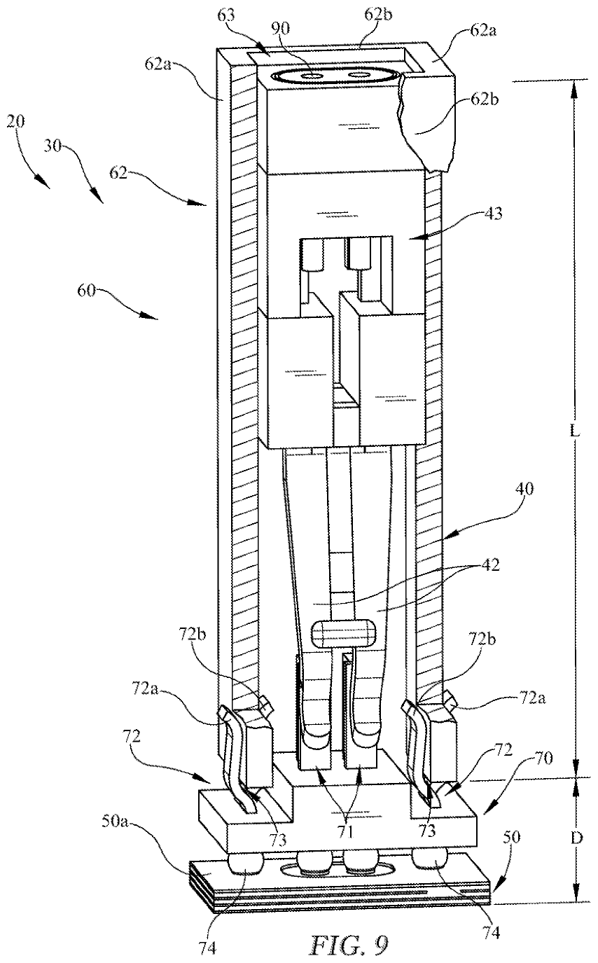

FIG. 9 is a perspective view of the electrical connector, illustrating the mating interface or plates surrounding the cable connector and/or spaced from the substrate for a distance.

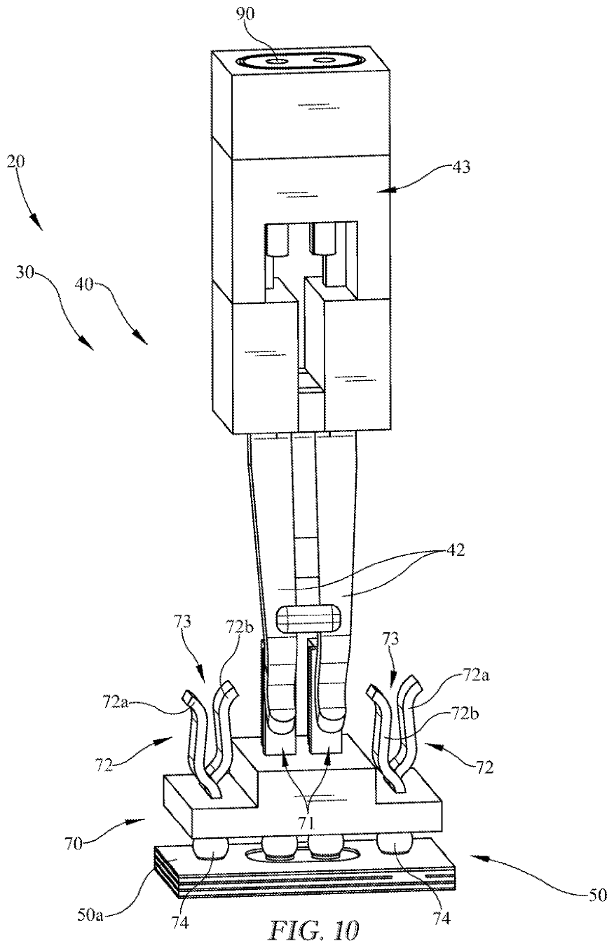

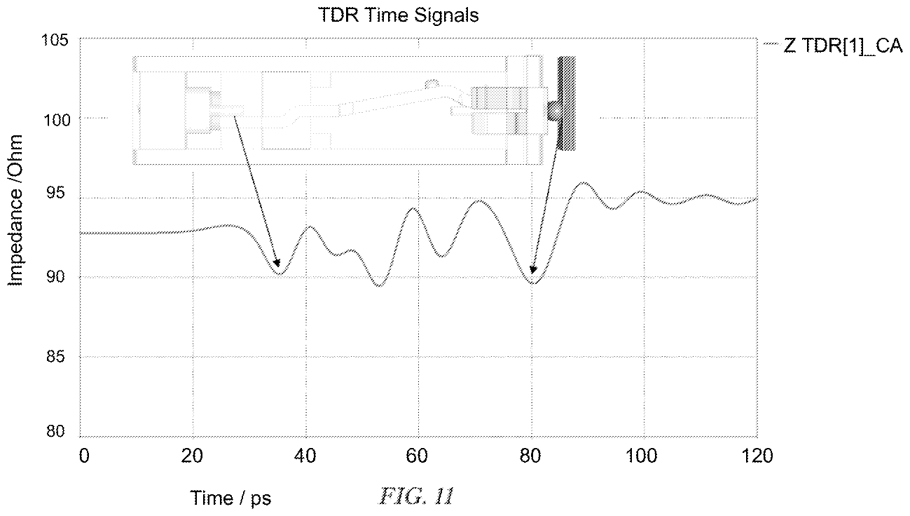

FIG. 10 is a perspective view of the electrical connector with the mating surface broken away.

FIG. 11 is a chart illustrating the impedance profile of the cable to the package for one embodiment.

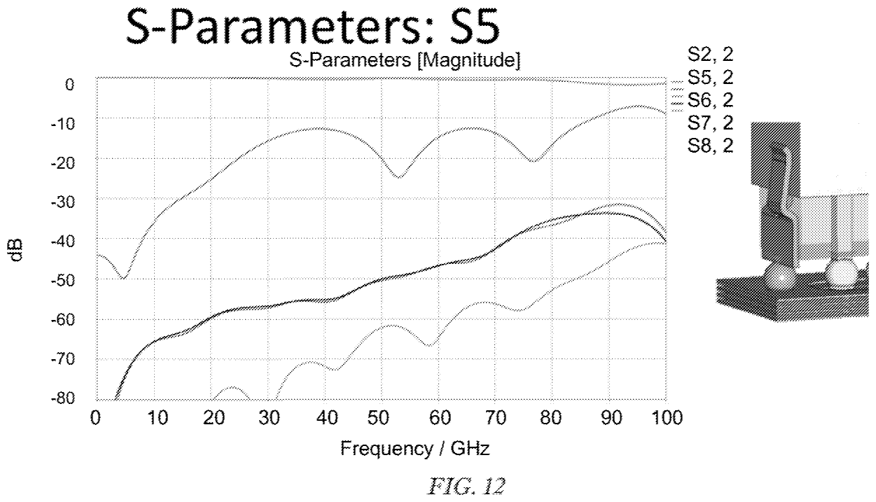

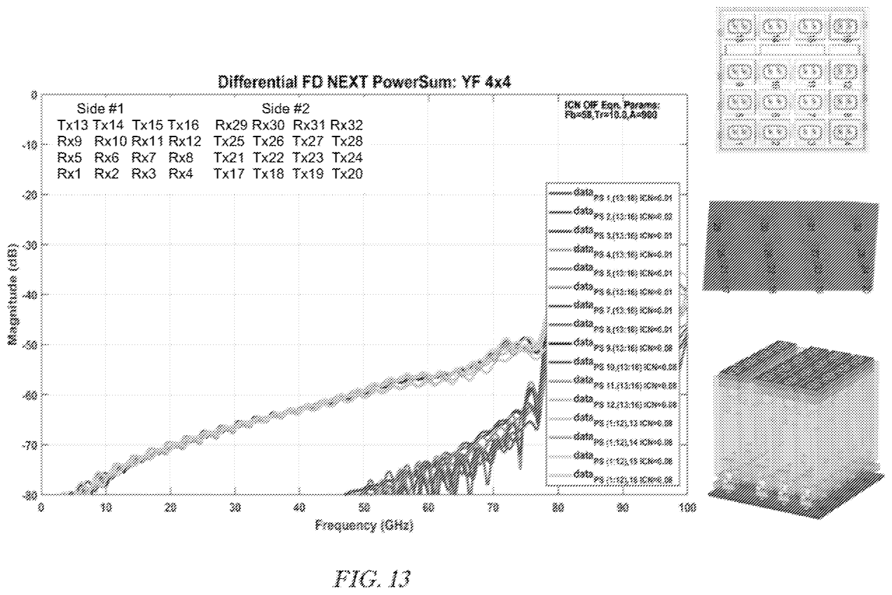

FIG. 12 is a chart illustrating the shield return path transition impact for one embodiment.

FIG. 13 is a chart illustrating the differential FD NEXT Power Sum for one embodiment.

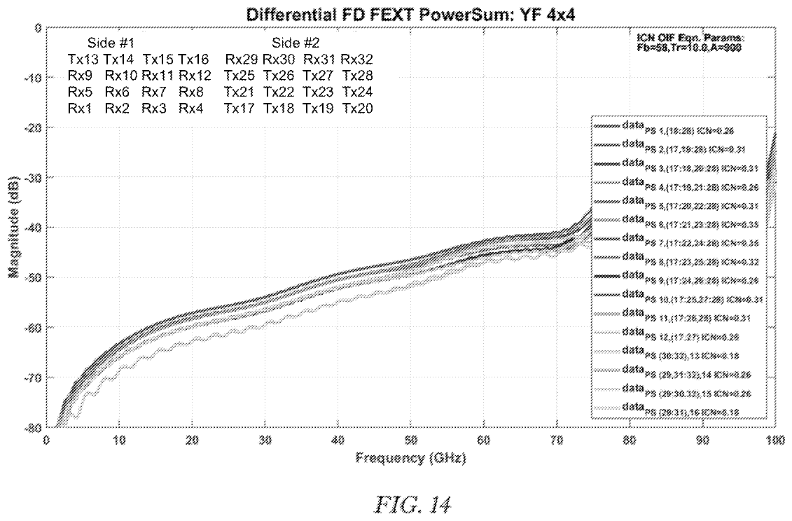

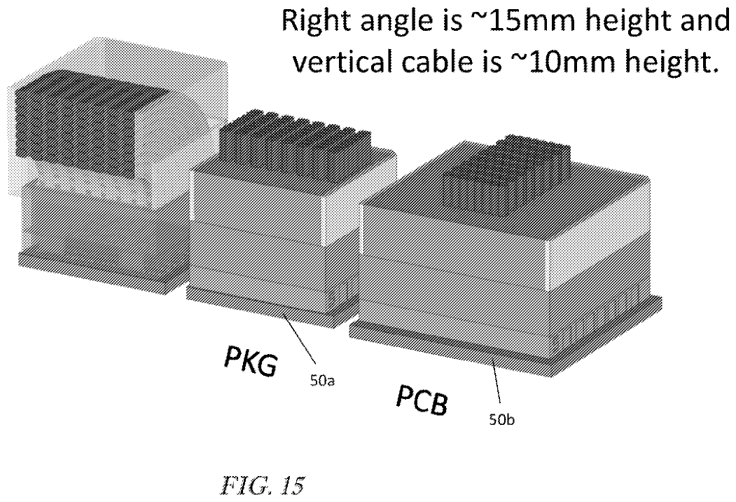

FIG. 14 is a chart illustrating the differential FD FEXT Power Sum for one embodiment.

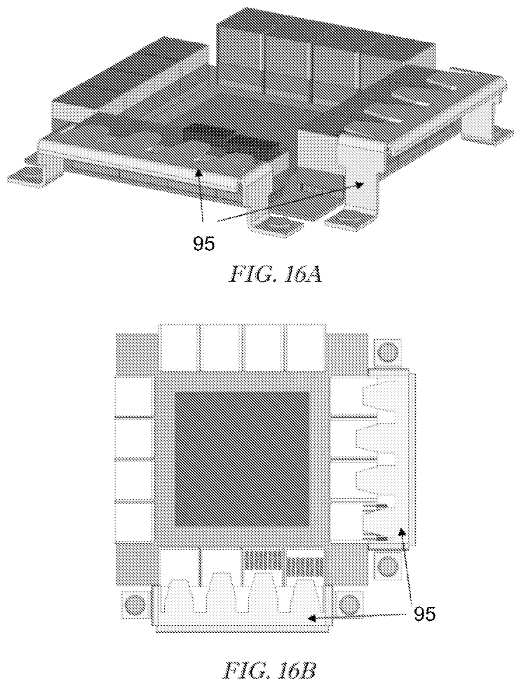

FIG. 15 illustrates a PKG and PCB embodiment of the 64 pair blocks.

FIGS. 16A and 16B illustrate an embodiment of a retention bracket.

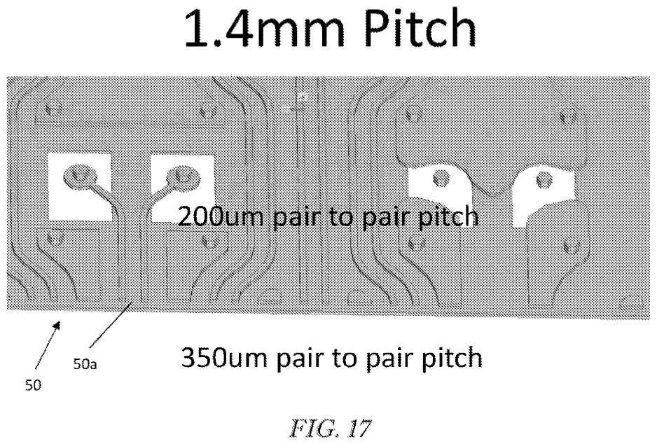

FIG. 17 is a portion of the PKG substrate routing.

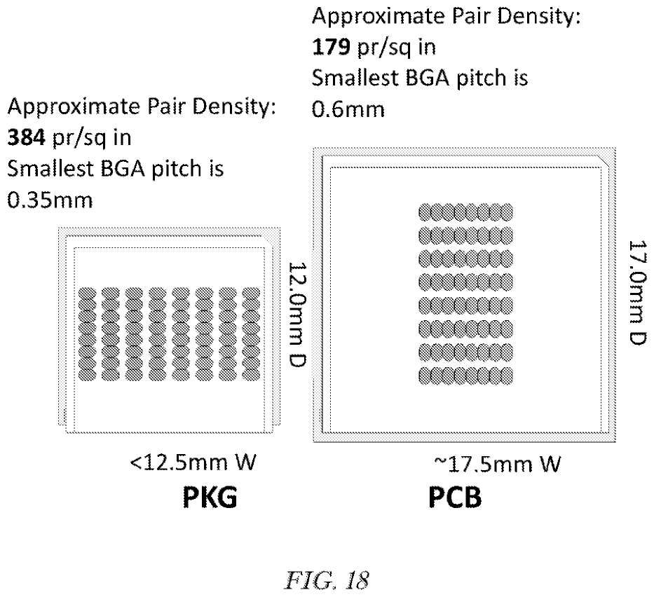

FIG. 18 is an embodiment of the PKG versus the PCB, the designs are rotated for vertical routing.

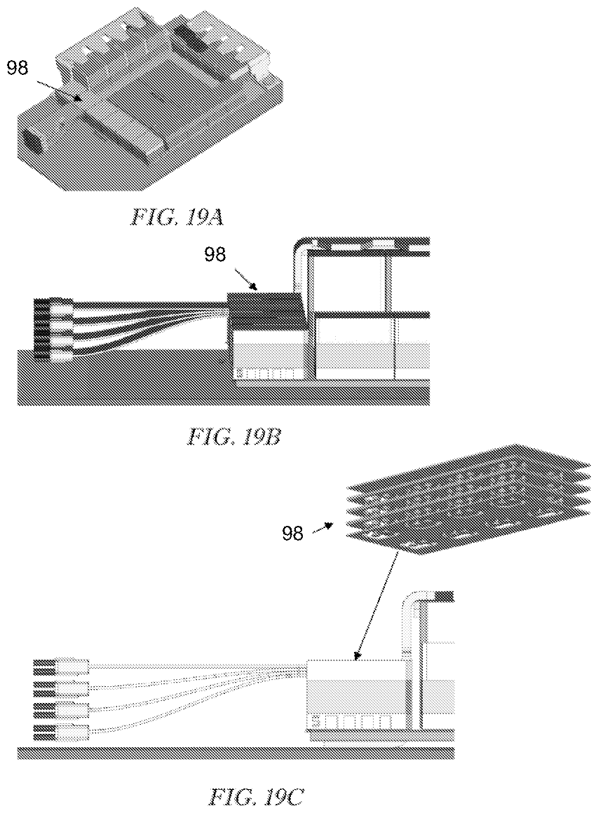

FIGS. 19A-19C are views of an embodiment of the Mezzanine, illustrating a height of less than 8 mm.

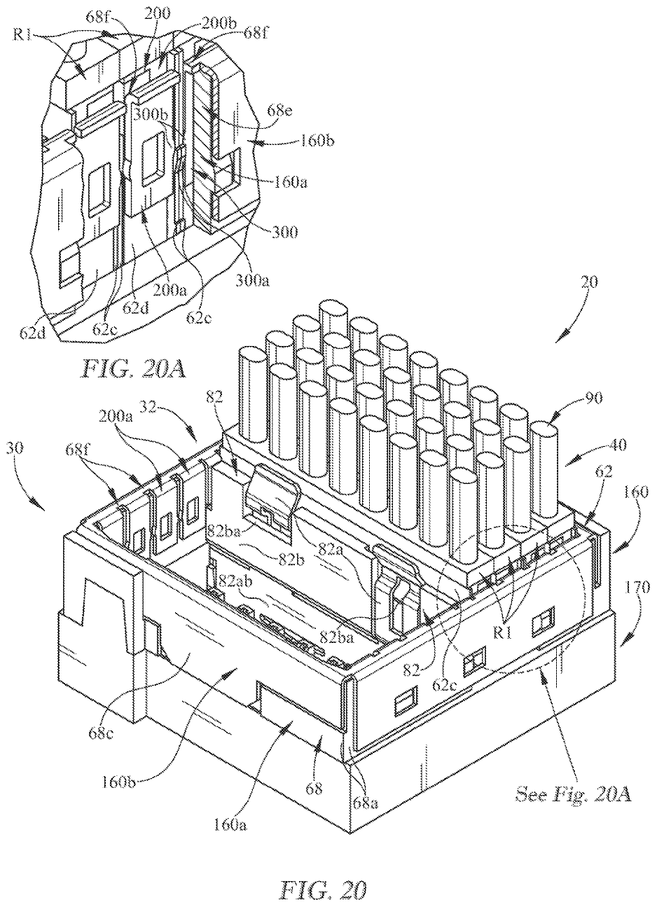

FIG. 20 is another embodiment of the electrical connector, with portions of the cable connector removed to illustrate a locking mechanism.

FIG. 20A is an enlarged sectional view of FIG. 20 illustrating the latch locking mechanism of the engagement between portions of the mating interface.

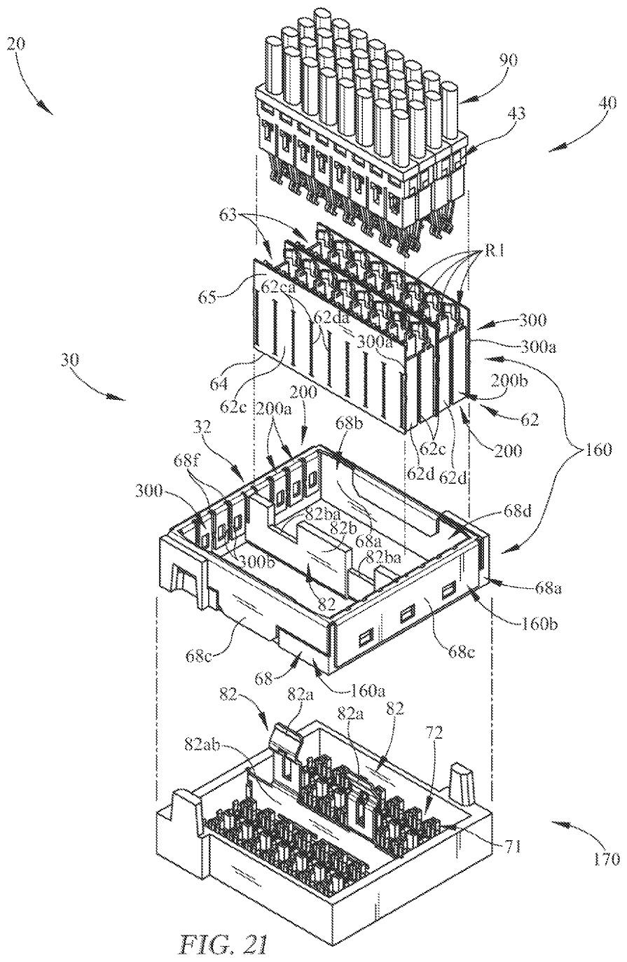

FIG. 21 is an exploded view of FIG. 20.

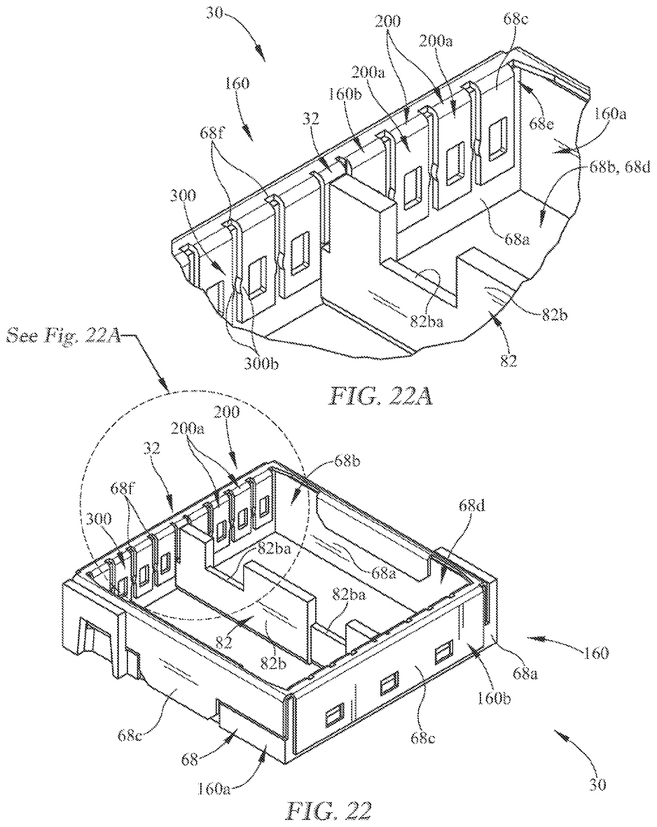

FIG. 22 is a perspective view of the mating interface, illustrating the assembled receptacle base and ground member.

FIG. 22A is an enlarged perspective view of FIG. 22.

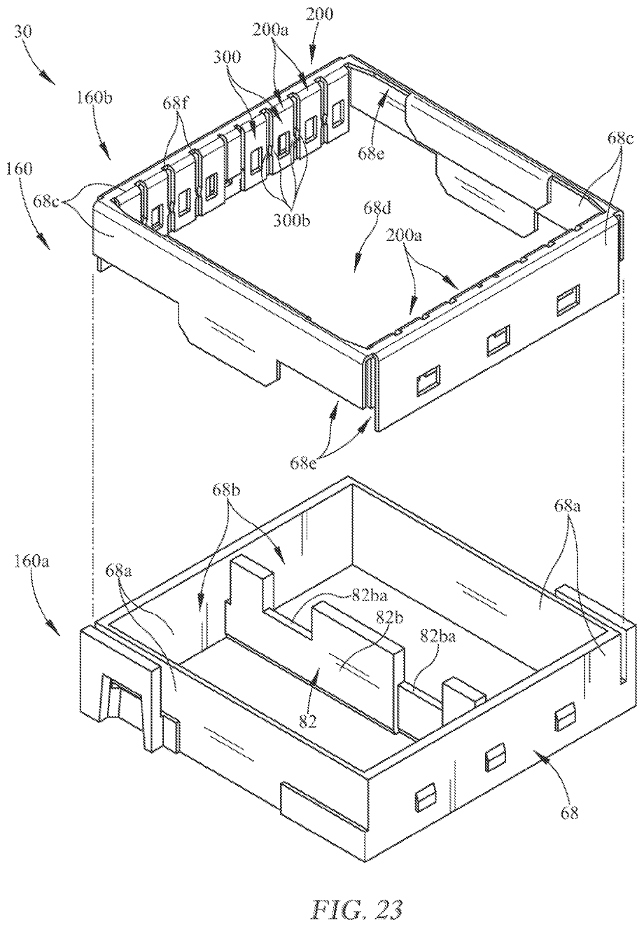

FIG. 23 is an exploded view of FIG. 22.

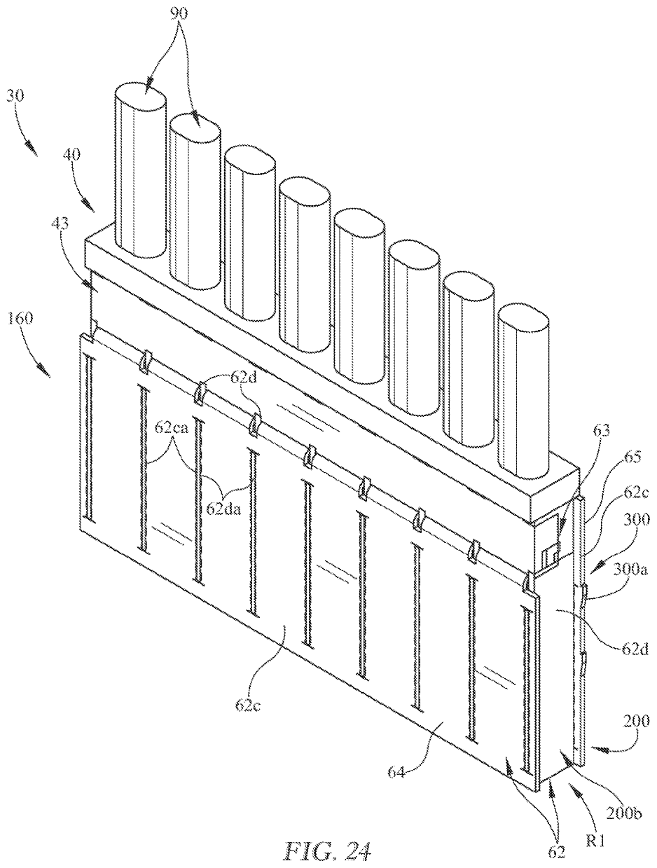

FIG. 24 is a perspective view of a row of cavities of the mating interface receiving a row or plurality of connectors.

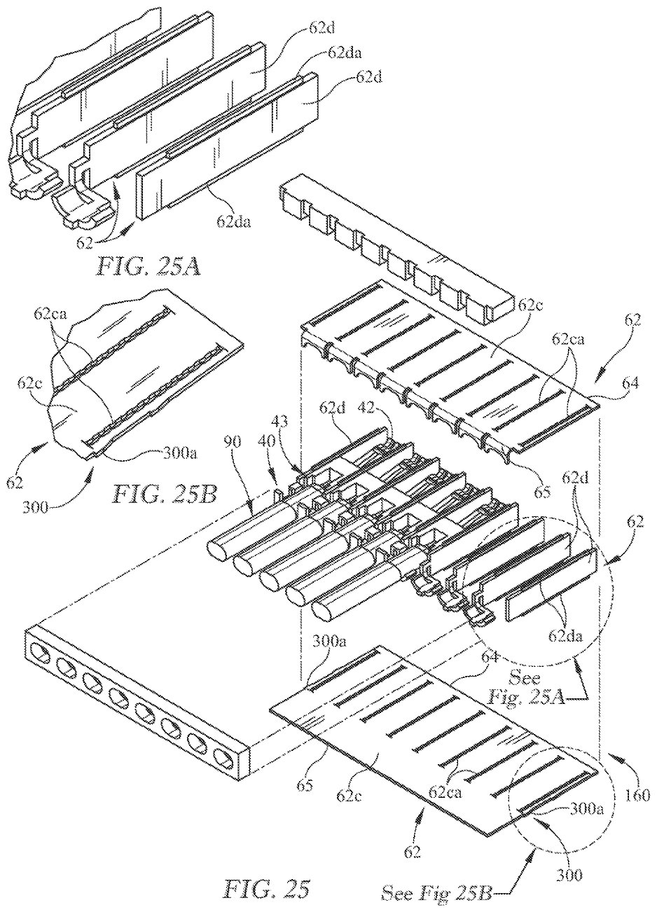

FIG. 25 is an exploded view of FIG. 24.

FIGS. 25A and 25B are enlarged perspective views of FIG. 25.

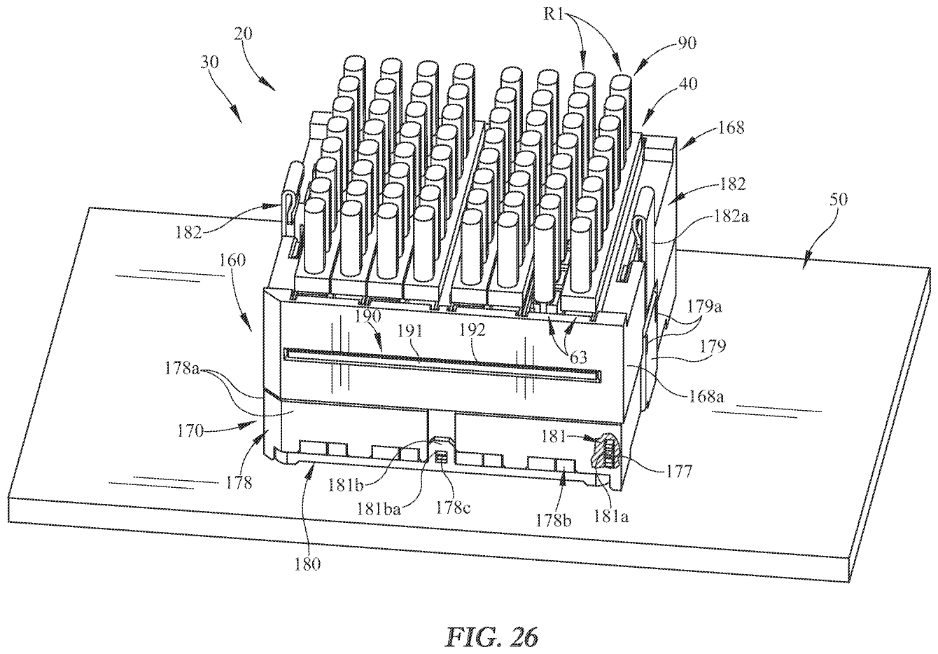

FIG. 26 is another embodiment of the electrical connector, with portions of the cable connector removed to illustrate a mating interface and portions of the plug connector broken away.

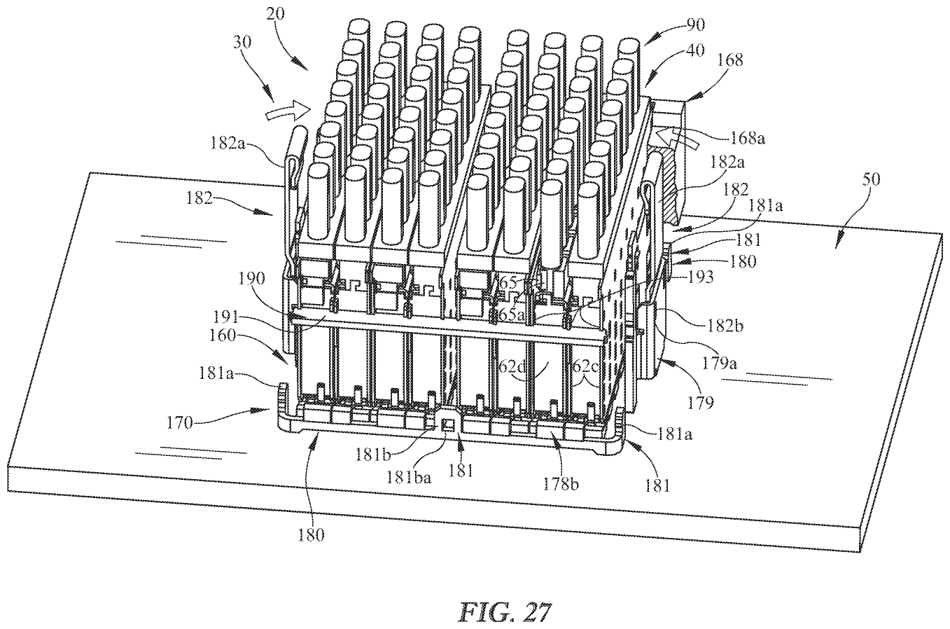

FIG. 27 is a perspective view of the electrical connector of FIG. 26, with portions of the housing of the mating interface broken away and portions of the housing of the plug connector removed to illustrate an embodiment of a stiffener and a retention member.

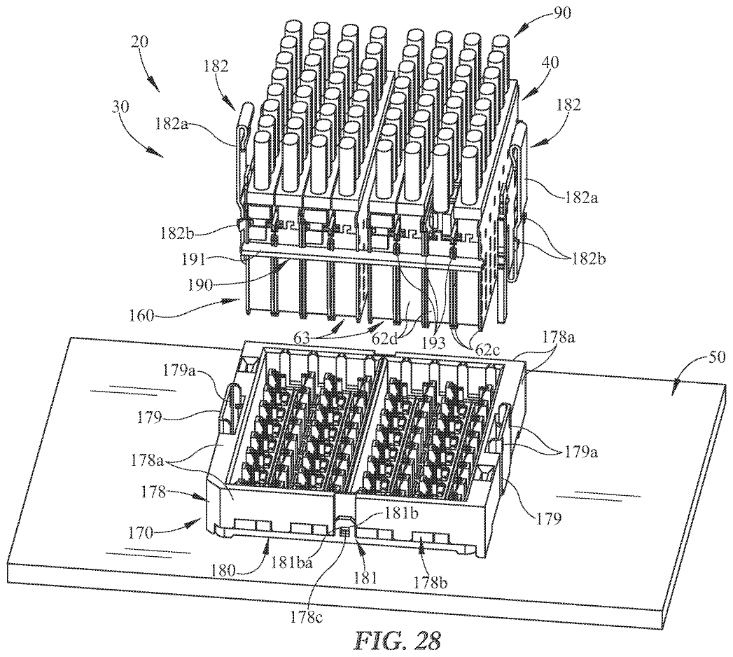

FIG. 28 is a perspective view of the electrical connector of FIG. 26, with the mating interface and cable connector exploded away from the plug connector, with portions of the housing of the mating interface removed.

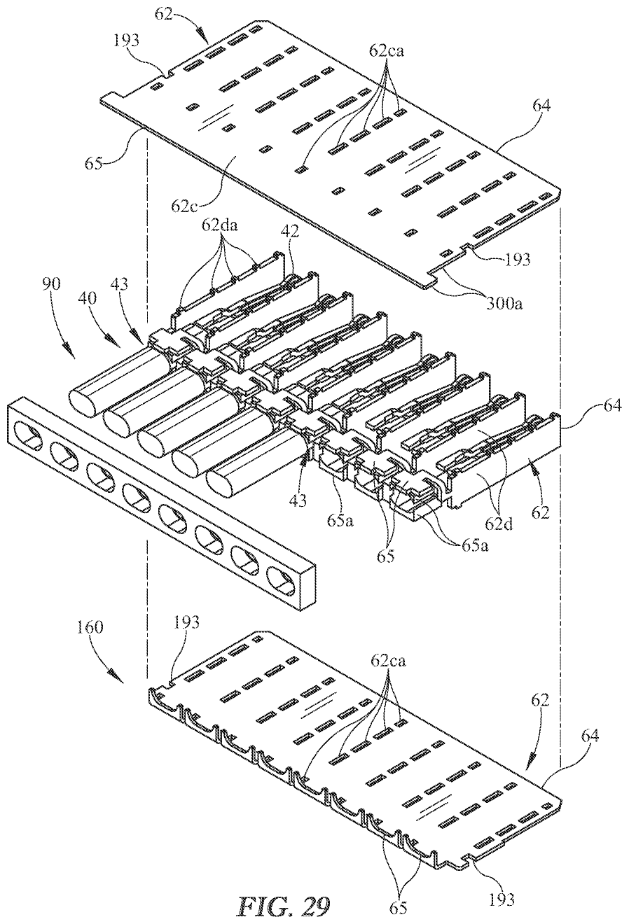

FIG. 29 is an exploded view of a row of cavities of the mating interface of FIG. 26 receiving a partial row or plurality of connectors.

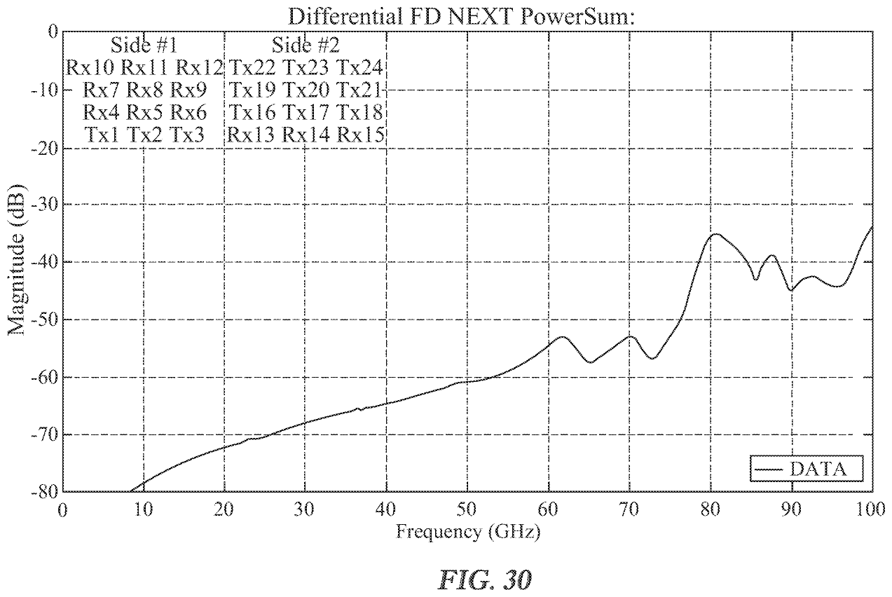

FIG. 30 is a chart illustrating the differential FD NEXT Power Sum for one embodiment shown in FIG. 26.

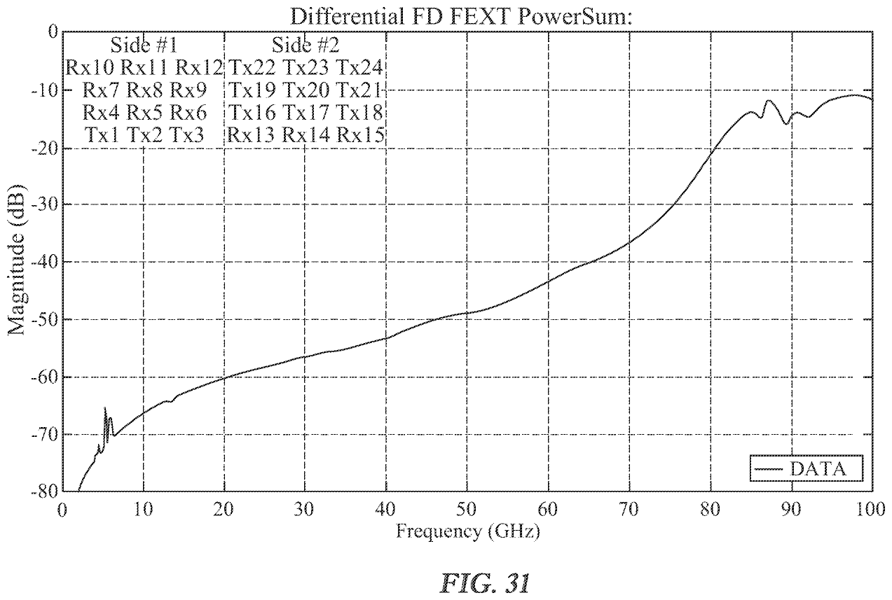

FIG. 31 is a chart illustrating the differential FD FEXT Power Sum for one embodiment shown in FIG. 26.

### DETAILED DESCRIPTION

Embodiments may further be understood with reference to the various Figures. With reference to Figures, an embodiment provides for one or more electrical connector assemblies 20. The assembly 20 may include at least one or more electrical connectors 30. In some embodiments, the electrical connectors may include a width of about 12.5 mm, operation at about 224 Gbps, and/or a package size of about 75 mm. The number of pairs may be 64 in less than half an inch or a density of greater than 256 pairs per square inch. In some embodiments, an electrical connector may be sized and shaped such that a plurality of the electrical connectors may fit on a single side of a die package substrate that is no larger than approximately 75 mm by 75 mm to approximately 85 mm to 85 mm, the plurality of electrical connectors may collectively carry at least 1024 differential signal pairs, and the plurality of electrical connectors transmit approximately 224 Gbps Pam4 signals at approximately 56 GHz to approximately 70 GHz of bandwidth with no more than approximately −40 dB of FEXT (far end crosstalk). In various embodiments, an electrical connector may be sized and shaped such that a plurality of the electrical connectors may fit on a single side of a die package substrate that is no larger than approximately 75 mm by 75 mm to approximately 85 mm to 85 mm, the plurality of electrical connectors collectively carry at least 1024 differential signal pairs, and the plurality of electrical connectors transmit approximately 224 Gbps Pam4 signals at approximately 56 GHz to approximately 70 GHz of bandwidth with no more than approximately −50 dB of NEXT (near end crosstalk). In some embodiments, the die package substrate with sides no larger than approximately 75-110 mm each, including approximately 80 mm±5 mm, 91 mm±5 mm, 95 mm±5 mm, 100 mm±5 mm, and 105 mm±5 mm, the plurality of electrical connectors collectively carry at least 1024 differential signal pairs, and the plurality of electrical connectors transmit approximately 224 Gbits/sec PAM-4 signals at approximately 56 GHz to approximately 70 GHz of bandwidth with no more than approximately −40 dB of FEXT.

Referring now to the Figures, FIGS. 1-4B illustrates an exemplary embodiment of an electrical connector assembly 20 according to an aspect of the present invention. Electrical connector assembly 20 includes an electrical connector 30 and/or a plurality of cable connectors 40 configured to mate with electrical connector 30. Electrical connector 30 may include or be connected to a circuit substrate 50, such as, e.g., die package substrate 50a, a printed circuit board 50b. As shown in the one embodiment, the connector 30 may be positioned/fit on a single side of the circuit substrate 50 (e.g. 50a, 50b). However, the connector 30 may be positioned on both sides in some embodiments. Referring to FIGS. 5 and 6, electrical connector 30 may include a mating interface or cable head organizer 60 (e.g. egg-crate mating interface or shield). The mating interface 60 may include a plurality of interlocking plates 62 defining a plurality of cavities 63. The connector 30 may include or is configurated to mate with one or more cable connectors 40. Each cavity 63 is sized for accepting or mating to the cable connector 40. The electrical connector 30 may include one or more plug connectors 70. The electrical connector 30 or plug connector 70 further includes one or more electrical contacts 71 and/or one or more ground contact elements 72. Each electrical contact 71 is positioned within the cavity 63, electrically isolated from interlocking plates 62, and configured to mate with a contact 42 (e.g. socket) of the cable connector 40. Contacts 42 can be non-compression type of contacts, such as beam to beam or beam to blade versus beam to pad. A plastic or dielectric web and optional button can be positioned between two immediately adjacent contacts 42, as described in U.S. Pat. No. 10,439,330, hereby incorporated by reference in its entirety. Contacts 42 can be electrically conductive. Contacts of each differential signal pair can be spaced approximately 0.3 mm to approximately 0.4 mm, including approximately 0.3 mm, approximately 0.35 mm, approximately 0.4 mm and all lengths therebetween. Differential pair to pair spacing can be approximately 1.4 mm, approximately 1.5 mm, approximately 1.6 mm, approximately 1.7 mm or approximately 1.8 mm and all lengths therebetween. Row to row spacing of differential signal pairs can be approximately 1.3 mm, approximately 1.4 mm, approximately 1.5 mm, approximately 1.6 mm, approximately 1.7 mm, or approximately 1.8 mm. Some rows can be spaced unevenly in an array of differential signal pairs, such as approximately 1.3 mm for some row spacing and approximately 1.7 mm centerline to centerline spacing between other adjacent rows. Each of the ground contact elements 72 may be electrically grounded and configurated to mate with at least one plate 62 (e.g. directly, indirectly, first plate, second plate). The plug connector 70 (e.g. ground contact elements, electrical contact) may be soldered to the circuit substrate 50 (e.g. 50a, 50b). In some embodiments as shown in FIG. 7, the 1024 pair solution may be used. In other embodiments as shown in FIG. 8, a 1192 or 1280 pair solution may be used.

In some implementations, at least one of interlocking plates 62 (e.g. first) may be electrically conductive and provides a ground connection between cable connector 40 and circuit substrate 50, or portions thereof. Generally, interlocking plates 62 may be electrically conductive or insulative. As shown in FIGS. 9 and 10, at least one interlocking plates 62 include a terminal end 64 spaced away from the circuit substrate 50 and a mating end 65 for electrically contacting an electrically conductive outer shield element 43 of the cable connector 40. To lower/control the impedance back and forth, a spacing or distance D from the circuit substrate 50 (e.g. package, 50a, 50b) to the terminal end 64 of the plate 62/shield 43 may be reduced by a length L of the plates 62 or cavities 63. The remaining portion of the length or distance D from circuit substrate to the terminal end 64 may be at least one source of the crosstalk. The plates 62 defining the cavity 63 cover or overlap about 85 to 95 percent of the length of the cable connector 40 to the package or substrate 50 to minimize the distance D. As shown in the one embodiment in FIG. 9, the plates 62 defining the cavity 63 covering/overlapping about 90 percent or the length L of the cable connector 40 to the package to reduce the crosstalk, while the remaining portion or distance D may be about 10 percent to the substrate. One embodiment of the impedance profile of the cable to package is shown in FIG. 11, the simulation shown with a TDR signal of 92Ω+/−5Ω at 6 ps (20%-80% rise time).

In some implementations, the terminal end 64 of the plates 62 or cavities 63 may be spaced (e.g. predetermined distance D) from the package/substrate 50. The terminal end 64 or plate 62 may abut/position/mate with the ground contact element 72 of the plug connector at the distance D. The contact element 72, or portions thereof, may space the plate 62, or portion thereof, (e.g. terminal end 64) from the substrate 50 at the distance D. In the one embodiment shown, the ground contact element 72 extends/projects from the circuit substrate 50 (e.g. 50a, 50b). The ground contact element 72 may include one or more arms/blades. For example, the ground contact element may include at least one arm, at least two arms, at least three arms, at least four arms, or four or more arms. The increase in the number of arm(s) may increase contact area/width when mating to the mating interface (e.g. plate(s)). As shown in the one embodiment, the ground contact element 72 may include two arms 72a, 72b (e.g. at least two laterally offset, cantilevered beams) extending upwardly and away from each other to define a slot 73 to receive the terminal end 64 of the plate(s) 62 (e.g. first). The two arms may diverge from the remaining portion of the ground contact element or body. The two arms 72a may be offset by a distance from each other along the length or plane of the slot 73 receiving the plate(s) 62. Although the arms may not overlap or cross along the length of the slot, it should be understood that a portion of the arms may overlap in some embodiments. The slot or one of more portions of the ground contact element 72 (e.g. arm(s)) may define a stop or vertical stopping mechanism for limiting further axial travel of the plate 62 within the slot or towards the circuit substrate. The stop may position the mating interface, plate, or cavity at the distance D. Further, the first and second arms 72a, b may be mirror images of each other with the plane of the slot 73. The first arm 72a engages the interior of one cavity/plate and the second arm 72b engages the interior of the adjacent cavity/plate. In the one embodiment shown, two ground contact elements 72 may engage adjacent and parallel plates 62 (e.g. first), and not the adjacent second plates defining the cavity 63 receiving the cable connector 40. However, in some embodiments, one or more ground contact elements 72 may engage one or more second plates and/or in combination with one or more first plates. In the one embodiment shown, each arm 72a, b may be spring loaded or biased to urge towards the slot 73 or engaged plate 62. Further, each arm or distal free end of the arm may flare/curve away from the slot or engaged plate. As shown in the one embodiment, the arms 72 may be surrounded by air or free space, without contact with a plastic or insulating member. No plastic may be between the mating ends of the ground contact elements 72 and the mating ends of the signal contacts 71. The mating ends of 71 and 72 may be unrestricted or not surrounded by plastic or insulating member(s). The arms 72 (e.g. mating ends) may be freestanding, project, and/or extend (e.g. not internal to plastic) above the plastic of plug connector 70 at the base of the arm. Further, there may be no plastic or insulating material along a line that extends between mating end of arm 72b and an immediately adjacent mating end of arm 72b. One example of the S-parameter of the shield return path or ground contact element is illustrated in FIG. 12. The simulation embodiment shown in FIG. 12 was conducted at 92Ω+/−5Ω at 6 ps (20%-80% rise time). In some implementations, the contact(s) may include one or more solder ball/masses 74. In the one embodiment shown, the ground contact element 72 includes at least one solder mass 74. It should be understood that the ground contact element 72 may include one or more solder masses. For example, at least one solder mass, at least two solder masses, or at least three solder masses. In some embodiments, the two or more solder masses may be immediately adjacent to each other (e.g. linearly aligned). In some embodiments, the soldering for the contacts may be one or more elongated pads of a variety of lengths. In some implementations, the electrical/signal contacts 71 may be perpendicular to the ground contact elements 72.

In a preferred embodiment, interlocking plates 62 are metal plates formed by any suitable method, such as, e.g., metal stamping. In other embodiments, interlocking plates 62 are formed by other means, including molding and/or machining of polymeric material, molding and/or machining of metal, or construction of a metal frame overmolded with a polymeric material. In some embodiments, a plastic frame/base may be plated.

In some implementations, interlocking/interconnected plates 62 include a plurality of first plates 62a and a plurality of second plates 62b as shown in FIGS. 5 and 6. The plate(s) 62 may include one or more grooves 66 and/or one or more slots 67. The grooves, if used, may be interlocking with the slots, if used, to define the cavities 63. The first plate 62a may include a plurality of first slots 67a aligned with a plurality of first grooves 66a. The second plate 62b may include a plurality of second slots 67b aligned with a plurality of second grooves 66b. Second plates 62b are transversely positioned and interconnected with respect to first plates 62a by interlocking first slot 67a with the second groove 66b and interlocking the second slot 67b with the first groove 66a such that when assembled, the plurality of first plates and second plates define the plurality of cavities 63. The slot/groove engagements 66, 67 or mating interface 60 provide a fully enclosed or 360 degree shield/circumference about one or more cable connectors 40. The 360 shield or plates reduce the crosstalk between the cable connectors within the cavities. This may prevent or reduce gaps/holes/pathways in the cavity walls to reduce crosstalk. The walls of the slot/groove engagements may abut or overlap edges of the opposing slot/groove engagement to reduce gaps. As shown in FIG. 13, the plurality of electrical connectors may transmit approximately 70 Ghz signals with no more than approximately −40 dB of FEXT (far end crosstalk). The simulation embodiment shown in FIG. 13 was conducted at 92Ω+/−5Ω at 6 ps (20%-80% rise time).

In some implementations, the mating interface 60 may include a housing 68. The housing 68, if used, may include a plurality of grooves 69 positioned in the inner periphery. The groove(s) 69 may maintain spacing of the cavities 63/plates 62 and/or provide rigidity to the one or more plates 62. The grooves 69 may receive the ends of the first plate 62a and the second plate 62b.

In some implementations, the electrical connector 30 may include one or more gaps/spaces 32 between the cable connectors 40 to reduce crosstalk. In some embodiments, the more space or distance between rows may lower NEXT of the PKG. In the one embodiment shown, the gap 32 may be defined by one or more rows of cavities 63 defined by the plurality of plates 62 that do not contain the cable connectors 40. The one or more rows without the cable connectors 40 or gaps 32 within the array of cable connectors 40 may reduce the crosstalk between the cable connectors 40. As shown in the one embodiment, the one or more rows/gaps 32 without the cable connectors 40 may be defined by a plurality of smaller cavities (e.g. smaller through opening) or closer spaced plates(s). The smaller row or gap 32, if used, may be defined by at least two adjacent and parallel plates (e.g. first plates 62a and/or second plates 62b) being spaced at a less distance than the remaining parallel plates. The grooves 66 and slots 67 may be positioned on the respective plates 62 to define the gap(s) 32 of a variety of row to row spacing/distances D. Although not shown, the intersecting plates 62 of both the first plates and the second plates may be spaced at a less distance (e.g. row to row) to define a smaller row. Further, as shown in FIG. 14, the plurality of electrical connectors may transmit approximately 70 Ghz signals with no more than approximately −50 dB of NEXT (near end crosstalk). The simulation embodiment shown in FIG. 14 was conducted at 92Ω+/−5Ω at 6 ps (20%-80% rise time).

In some implementations, the assembly/connector, or portions thereof (e.g. mating interface, plug connector, and/or cable connector) may be a 224 Gbps Pam4 signal with 92Ω+/−5Ω at 6 ps with 20%-80% rise time as simulated in one embodiment. In some embodiments, the bandwidth may be about 70 to 50 GHz. In some embodiments, the bandwidth may be about 56 GHz. In various embodiments, the FEXT may be about −30 dB to about −45 dB. For example, under or equal to −30 dB, under or equal to −35 dB, under or equal to −40 dB, and/or under or equal to −45 dB. In some embodiments, the insertion loss may be between about 0 dB to about −5 dB. For example, between 0 dB and −1 dB, between −1 dB and to −2 dB, between −2 dB and to −3 dB, between −3 dB and to −4 dB, and/or between −4 dB and to −5 dB. The bandwidth may be about 50 GHz to about 80 GHz. For example, 50 GHz, 55 GHz, 60 GHz, 65 GHz, 70 GHz, 75 GHz, and/or 80 GHz. In various embodiments, the NEXT may be about −40 dB to about −60 dB. For example, under or equal to −40 dB, under or equal to −45 dB, under or equal to −50 dB, under or equal to −55 dB, and/or under or equal to −60 dB. In some embodiments, the insertion loss may be between about 0 dB to about −5 dB. For example, between 0 dB and −1 dB, between −1 dB and to −2 dB, between −2 dB and to −3 dB, between −3 dB and to −4 dB, and/or between −4 dB and to −5 dB. The bandwidth may be about 50 GHz to about 70 GHz. For example, 50 GHz, 55 GHz, 60 GHz, 65 GHz, and/or 70 GHz.

In some implementations, the assembly 20 or electrical connector 30 may include a bend/cable organizer 80 for one or more cables 90. The bend/cable organizer 80 may include a strain relief 81 in some embodiments. The strain relief 81, if used, may be a hot melt. As shown in FIGS. 3A and 15, the bend organizer 80 may be used with a vertical cable 90a or a right-angle cable 90b. The overall height of the electrical connector 30 or assembly 20 may be less than 15 mm. The right-angle cable 90b with bend organizer 80 may define a height of about 15 mm. The vertical cable 90a with bend organizer 80 may define a height of about 10 mm.

In some implementations, one or more cables 90 may be connected to the one or more cable connectors 40. Although the cable 90 is shown as a twin cable in the one embodiment shown, it should be understood that a variety of cables may be used and still be within the scope of the invention. For example, a coax cable may be used in some embodiments. Cable 90 can include a shield, such as a wrapped shield or an extruded shield or any type of ground, or reference, or EMI shield. The shield can be stripped with respect to an exposed surface of the center electrical insulator, can be partially stripped, but is not limited to, a length of greater than zero mm to approximately 1 mm to 2 mm, or zero mm, or 2 mm or larger, or zero mm to 0.5 mm. Any of the connectors may include electrically conductive or electrically lossy, magnetic absorbing material.

In some implementations, the assembly 20 or electrical connector may include one or more retention brackets 95. As shown in FIGS. 16A and 16B, one example of a retention bracket 95 may be one or more spring fingers. The retention device, if used, may ensure mated parts and/or allow service. Another example of the retention bracket may be latching.

In some implementations, the circuit substrate 50 may have a routing determining density. For example, as shown in FIG. 17 the PKG or die substrate package may start with a 350 um pitch to minimize FEXT and squeeze the pitch down to 200 um as route pass vias. The BGA pitch of 0.35 may determine the routing density (e.g. 224 Gbps). There may be a PCB embodiment of 64 pair blocks. The PCB version may be about 5 mm wider and deeper than the die substrate package as shown in FIG. 15. Further, one embodiment of the PKG versus the PCB embodiment is shown in FIG. 18. The designs are shown rotated for vertical routing. The PKG may be 2 layers and the PCB may be 4/8 layers.

In some implementations, the electrical connector assembly may include a lower RA height option. For example, the cable organizer may be less than 8 mm with compatibility. As shown in FIGS. 19A-19C, the configuration may be a stacked flex 98 in a mezzanine configuration. One example as shown, may be four 3-layer flex films, stacked and one soldered to the connector. The flex 98 may be converted to one or more cables for longer lengths.

In some implementations, the electrical connector assembly 20, electrical connector 30, mating interface 60, 160, substrate 50, and/or plug connector 70, 170 may include one or more locking mechanisms 82, or portions thereof, coupling the mating interface 160 with the plug connector 170. In the one embodiment shown in FIGS. 20-23, the locking mechanism 82 may be a middle or internal locking mechanism spaced or positioned inwardly from or within the outer periphery (e.g. outer housing, walls) of the electrical connector 30/connector 170/mating interface 160. The locking mechanism 82 may include one or more latches, clips, or friction locks 82a (e.g. middle, internal). The one or more clips 82a are shown internal or inside to/within the plug connector 170, mating interface 160, and/or electrical connector 30 (e.g. outer periphery). Although the clips 82a are shown internal to the electrical/plug connector 30, 170 and/or mating interface 160, it should be understood that external clips (e.g. positioned on the outer periphery, wall) may be used in combination with the internal clip(s)/locking mechanism in some embodiments. The one or more clips 82a project upwardly from the bottom of the plug connector 170 and/or substrate 50, and/or spaced interior of the outer periphery. The clips may project upwardly from a middle or internal wall 82ab extending between or within the outer peripheral walls (e.g. opposing walls) of the mating interface 160 (e.g. base, ground member) or plug connector 170. In the one embodiment shown, two spaced apart clips 82a may be spring loaded in a transverse direction (e.g. opposing directions, inwardly towards opposing sides of the internal panel 82b) to the plane of the clips 82a and/or internal wall 82ab. The clips 82a apply friction to the locking mechanism 82 of the mating interface 160, or portions thereof, (e.g. internal panel 82b, catches 82ba) to reduce or prevent axial separation between the mating interface 160 and the plug connector 170. The locking mechanism 82, or portions thereof, of the mating interface 160 may be one or more receptacles/catches 82ba and/or internal panel 82b releasably engaging the one or more clips 82a. When assembled, the clips 82a engage the internal panel 82b, or portions thereof, (e.g. upper notches/catches/receptacles 82ba) of the mating interface 160. The clips 82a of the plug connector 170 interfere with the axial separation of the mating interface 160 or internal/middle panel 82b. The internal panel 82b may be positioned in the gap 32 between the cable connectors 40 and/or cavities 32 (e.g. rows of cable connectors). The internal panel 82b may include one or more notches/catches 82ba in the upper edge thereof. If two notches 82ba are used, the notches may be spaced away from each other along the length of the panel 82b. One or more portions of the locking mechanism 82 may be reversed between the mating interface 160 and the plug connector 170. For example, it should be understood in some embodiments the mating interface 160 may include the clips and the plug connector 170 may include the internal panel.

In the one embodiment shown in FIGS. 20-25, the mating interface 160 may include a plurality of interlocking plates 62 defining at least one row R1 of cavities 63 receiving at least one row or one or more cable connectors 40. The interlocking plates 62 may include at least two third/opposing/parallel plates 62c interconnected by one or more fourth/parallel plates 62d transverse to the third plate. The fourth plates 62d may define opposing end plates at the opposing ends of the row of cavities or third plates 62c. Each row R1 may include the third and fourth plates. The mating interface 160 may include a plurality of rows R1 defined by the third and fourth plates. The cavities 63 may have a through opening (e.g. open top and open bottom) defined by the third and fourth plates 62c, 62d. In some embodiments, the third plates 62c may include one or more through apertures 62ca receiving one or more projections 62da extending from the outer periphery (e.g. opposing ends/sides) of the fourth plates 62d when assembled. As shown in the one embodiment in FIGS. 24, 25, and 25B, the third plate(s) 62c may include one or more through apertures or elongated slots 62ca (e.g. in the direction between the mating end 65 towards the terminal end 64). As shown in FIGS. 24, 25, and 25A, each fourth plate 62d may include one or more protrusions or elongated protrusion 62da on opposing sides/edges, engaging the corresponding elongated slots 62ca of opposing third plates 62c. The mating end 65 of one or more of the third plates 62c and/or the fourth plates 62d may include a plurality of curved edges to mate or contour with the one or more cables 90 or cable connector 40. The other of the opposing/parallel third plate 62c may be longer than and extend beyond the curved edges, if used, as shown in FIGS. 24 and 25. In some embodiments, solder paste may be used adjacent the engagement of the apertures/projections. The cavities defined by the third and fourth plates 62c, 62d may receive the cable connectors 40. The end plates or fourth plates 62d may be spaced inwardly from the opposing ends of the third plates or rows R1 to define a groove 200b. The groove 200b may include a bottom opening to receive or insert the tongue member 200a of the remaining portion of the mating interface 160 (e.g. base, ground member). The third/fourth plates 62c, 62d (e.g. ground, metal) may be stamped and/or plated. In some embodiments, the plates 62 may be cream solder printed, solder plated, and/or laser welded together. The cavities or third and/or fourth plates may be assembled with one or more hot blades with the one or more cable connectors 40 therein. When assembled, a row R1 of cavities defined by the third and fourth plates 62c, 62d are positioned adjacent to one or more rows R1 of cavities. Adjacent third plates 62c of adjacent cavities/rows R1 may be positioned parallel to and/or in contact with each other as shown in FIGS. 20, 20A, and 21. As shown in the one embodiment in FIG. 20, the locking mechanism 82, or portions thereof, internal wall 82ab, gap 32, internal panel 82b, notch 82ba, and/or clip 82a may space two adjacent rows R1 from each other.

In some implementations, the mating interface 160 may include the plates (e.g. third, fourth, etc.), a receptacle base 160a, and/or a ground member 160b. In some embodiments, the receptacle base 160a may be, but is not limited to, molded plastic and/or the ground member 160b may be, but is not limited to, stamped metal (e.g. conductive). The base 160a or mating interface 160 may include one or more internal panels 82b and/or locking mechanism(s) 82, or portions thereof, in some embodiments. The base 160a may include the housing 68 having an outer peripheral wall(s) 68a defining a through opening 68b. The internal panel 82b may be inside or within the outer periphery and extend between opposing walls of the outer peripheral walls 68a and/or intersecting the through opening 68b. The ground member 160b may include an outer peripheral wall 68c defining a through opening 68d. The outer peripheral wall 68c of the ground member 160b may include a channel 68e (e.g. U-shaped, inverted channel). The ground member outer peripheral wall 68c may mate with the base outer peripheral wall 68a. The channel 68e or ground member walls 68c may receive the upper edge of the base outer peripheral walls 68a. The mating interface 160 may include one or more tongue and groove engagements 200. Opposing walls 68c of the ground member 160b may include one or more tongue members or mating surfaces 200a, adjacent opposing walls of the base 160a. The tongue members 200a are positioned along at least one wall of the base 160a/ground member 160b and may be spaced away from each adjacent tongue member 200a along the wall(s) by a slot 68f (e.g. vertical, longitudinal). Although not shown, the slot 68f may increase in width from distal free end of the tongue towards the proximal end or upper edge of the ground member. For example, the slot may include an upper slot portion larger than a lower slot portion. The tongue members may be interior to the outer peripheral walls 68a and mate/engage with the one or more grooves 200b of the one or more rows R1/opposing ends of the third and/or fourth plates 62c, 62d of the mating interface. Although not shown, the tongue members, or portions thereof, may be spaced inwardly away from the interior surface of the base walls 68a. The plates 62c, 62b may contact one or more walls 68c (e.g. opposing walls, one wall, two walls, three walls, etc.) of the ground member 160b and/or adjacent plates/rows (e.g. 62c, 62b).

In some implementations, the plates 62c, 62d defining the one or more rows R1 of cavities 63 may engage the ground member 160b and/or base 160a by one or more latches. In the one embodiment shown in FIGS. 20-24, the latch may be one or more tongue and groove engagements 200 between the plates 62 (e.g. third and fourth) and the ground member 160b and/or base 160a. It should be understood that a variety of engagements or latches may be used between the plates 62 and the ground member 160b. The one or more opposing tongues 200a of the base/ground member engage or are received by the opposing grooves 200b or ends of the one or more rows R1 of cavities 63 defined by the third and fourth plates, and/or positions the third plates 62d of adjacent rows R1 in contact with each other when assembled. The tongues 200a and/or grooves 200b adjacent opposing walls of the ground member 160b may be adjacent the opposing ends of the internal panel 82b, if used. The ends of the third plates 62c or groove 200b (e.g. a portion of the row R1) may extend between the tongue 200a, or portions thereof (e.g. slots 68f), and/or the base wall 68a to slidable engage the tongue and groove engagement therebetween. A latch locking mechanism 300 may be used in some embodiments to axially lock the tongue and groove engagement 200 or mating interface portions therebetween. In the one embodiment shown in FIGS. 20-25, latch locking mechanism 300 may be a releasable engagement between the ground member 160b and the plates 62 (e.g. 62c, 62d) and/or row(s) R1. As more clearly shown in FIG. 20A, one or more third plates 62c may include one or more protrusions 300a adjacent to and projecting outwardly from the opposing ends of the one or more rows R1 that releasably mate with one or more protrusions 300b extending away from or laterally from adjacent tongues 200a into the slot 68f therebetween. The protrusion(s) 300b, if used, may narrow a portion of the slot 68f between adjacent tongues 200a. The latch locking mechanism 300 (e.g. protrusions 300a, 300b, openings, etc.), if used, may engage upon axial engagement/traveling (e.g. sliding) for a distance when engaging the tongue and groove engagements 200. For example, relative sliding therebetween of the tongue and groove engagement results in engagement (e.g. axial) of the one or more protrusions 300a of the row of cavities/plates of the mating interface containing the cable connectors 40 with the one or more protrusions 300b of the ground member and/or base of the mating interface. Further, when the mating interface 160 is assembled to the plug connector 170, the clip(s) 82a, if used, may extend upwardly between the internal panel 82b and the adjacent third plate 62c of the row(s) R1 of cavities/connectors on one or both sides of the internal panel. If two clips 82a are used as shown in the one embodiment, the clips may extend along or mate with opposing sides of the internal panel 82b of the base 160a.

In some implementations, the electrical connector 30 and/or cable connector 40 may include the shielding (e.g. 60, 160) of the differential signal pairs while the plug connector 70, 170 does not provide shielding of the differential signal pairs. As shown in FIGS. 1, 21, and 26, the plug connector 70, 170 is devoid of its own, separate circumferential shielding or egg-crate shielding (e.g. crosstalk). Only the electrical connector 30 and/or cable connector 40 includes the circumferential, egg-crate shielding (e.g. crosstalk) or mating interface 60, 160 of the differential signal pairs.

In some implementations, the electrical connector assembly 20, electrical connector 30, mating interface 60, 160, substrate 50, and/or plug connector 70, 170 may include one or more locking mechanisms 182, or portions thereof, coupling the mating interface 160 with the plug connector 170 (e.g. housing, substrate). In the one embodiment shown in FIGS. 26-29, the locking mechanism 182 may be an external locking mechanism positioned within the outer periphery (e.g. outer housing, walls) of the electrical connector 30/connector 170/mating interface 160. The locking mechanism 182 may include one or more latches or clips 182a (e.g. external). The one or more clips 182a are shown external to the plug connector 170, mating interface 160, and/or electrical connector 30 (e.g. outer periphery). Although the clips 182a are shown external to the electrical/plug connector 30, 170 and/or mating interface 160, it should be understood that internal clips (e.g. positioned on the outer periphery, wall) may be used in combination with the external clip(s)/locking mechanism in some embodiments. The one or more clips 182a project downwardly from the bottom of the mating interface 160 or be included in the housing 168 of the electrical connector 30. The clips 182a may project downwardly from one or more exterior walls 168a (e.g. opposing) to releasably engage the plug connector 170 (e.g. housing 178, exterior wall 178a, receptacle 179). One or more receptacles 170 within the housing 178 and/or exterior wall 178a of the plug connector 170 may releasably receive the one or more clips 182a. The receptacle 179 may project from or engage the die package substrate 50 (e.g. 50a, 50b). In the one embodiment shown, two spaced apart clips 182a may be spring loaded in a transverse direction (e.g. opposing directions, inwardly towards the connector) to the plane of the clips 182a. The clips 182a may include one or more protrusions 182b releasably engaging one or more apertures 179a of the receptacle 179 or housing 178. It should be understood that the clips 182a and the receptacle 179 may be reversed and still be within the scope of the invention.

In some implementations, the plug connector 170 (e.g. housing) and/or circuit substrate 50 may include one or more stiffeners 180. The stiffeners 180 may support one or more portions of the plug connector 70, 170. As shown in the one embodiment in FIGS. 26-29, the one or more stiffeners 180 may attach to the board side of the circuit substrate 50 and/or engage one or more portions of the housing 178 (e.g. bottom 178b, exterior wall 178a). One stiffener may engage three exterior walls 178a in some embodiments as shown, or a single exterior wall or the entire periphery of the exterior wall in some embodiments. The embodiment shown includes two opposing stiffeners. The stiffener may include one or more upwardly projection members/tabs 181 engaging the housing 178 (e.g. walls). The tabs 181 may include one or more posts 181a received within receptacles 177 of the housing 178 and/or one or more posts 181b having an aperture 181 ba receiving a biased tab 178c of the housing 178. The stiffener may support an outer periphery or edge of the bottom/substrate wall 178b or housing 178 in some embodiments. The stiffener, or portions thereof, may be made of an electrically conductive material, electrically non-conductive material, or both. In some embodiments, the stiffener may be stainless steel. It should be understood that the stiffener may be a variety of shapes, sizes, quantities, positions, and constructions and still be within the scope of the invention.

In some implementations, the assembly 20, cable connectors 40, and/or mating interface 60, 160 may include one or more retention members 190. The one or more retention members 190 may align or retain the engagement (e.g. conductive, non-conductive) between one or more portions of the mating interface 160. The retention member 190 may retain and/or align (e.g. horizontally, vertically) the plates 62, cavities 63, egg-crate shielding, or mating interface, or portions thereof, therebetween in some embodiments. The retention member 190 may retain and/or align (e.g. horizontally, vertically) the egg-crate shielding, cavities 63, plates 62 with the housing 168 in some embodiments. In the one embodiment shown in FIGS. 26-29, the retention member 190 may be a one or more elongated members or bars 191 (e.g. horizontal) engaging one or more elongated slots/apertures 192 of the housing 168 (e.g. wall(s)) and/or one or more slots/apertures 193 of the plates 62/cavities 63/egg-crate shielding. The retention member, or portions thereof, may be made of an electrically conductive material, electrically non-conductive material, or both. It should be understood that the retention member/mechanism may be a variety of shapes, sizes, quantities, positions, and constructions and still be within the scope of the invention.

In some implementations, one or more ends 65 of one or more plates 62 may electrically contact an electrically conductive outer shield element 43 of the cable connector 40. As shown in FIGS. 24, 25, and 25A, the mating end 65 of one or more of the third plates 62c and/or second plates 62d may include a plurality of curved edges to mate or contour with the one or more cables 90 or cable connector 40 (e.g. outer shield element 43). The mating end 65 may be in direct contact with the outer shield element 43 in some embodiments. As shown in FIGS. 26-29, the mating end 65 of one or more of the third plates 62c may include a plurality of flat edges to mate or contour with the one or more cables 90 or cable connector 40 (e.g. outer shield element 43), or portions thereof. Further, in some embodiments, the mating interface 160 and/or connector 30 may include an epoxy 65a at one or more conductive engagements. For example, as shown in the one embodiment in FIGS. 26-29, an epoxy 65a (e.g. conductive) may be used between the planar shaped mating end 65 or one or more portions of the plate(s) 62 (e. g. mating end) and the outer shield element 43.

In some implementations, FIGS. 30 and 31 illustrate the differential FD Next Power Sum and the differential FD FEXT Power Sum for one embodiment of the electrical connector shown in FIGS. 26-29. As shown in FIG. 30, the plurality of electrical connectors may transmit approximately 70 Ghz signals with no more than approximately −50 dB of NEXT (near end crosstalk). The simulation embodiment shown in FIG. 30 is the total power sum, industry standard summation of all noise sources. Further, as shown in FIG. 31, the plurality of electrical connectors may transmit approximately 70 Ghz signals with no more than approximately −30 dB of FEXT (far end crosstalk). The simulation embodiment shown in FIG. 31 is the total power sum, industry standard summation of all noise sources.

In some implementations, the assembly/connector 20, 30, or portions thereof (e.g. mating interface, plug connector, circuit substrate, and/or cable connector) may include at least 257 differential pairs per square inch, at least 256-264 differential pairs per square inch, at least 139-263 differential pairs per square inch, at least 138-145 differential pairs per square inch, and/or at least 88 to 137 differential pairs per square inch.

In some implementations, the assembly/connector 20, 30, or portions thereof (e.g. mating interface, plug connector, circuit substrate, and/or cable connector) may include at least 257 single ended pins per square inch, at least 256-264 single ended pins per square inch, at least 139-263 single ended pins per square inch, at least 138-145 single ended pins per square inch, and/or at least 88-137 single ended pins per square inch

In some implementations, the assembly/connector 20, 30, or portions thereof (e.g. mating interface, plug connector, circuit substrate, and/or cable connector) may include at least 127 differential pairs per linear inch, at least 128 differential pairs per linear inch, and/or at least 129 pairs per linear inch.

In some implementations, the assembly/connector 20, 30, or portions thereof (e.g. mating interface, plug connector, circuit substrate, and/or cable connector) may include conductors of approximately 30, 31, 32, 33, 34, 35, and/or 36 AWG. One range of the conductors may be, but is not limited to, about 30 to about 36 AWG, about 30 to about 34 AWG, and about 32 to about 36 AWG. Approximately 33 AWG and/or approximately 34 AWG are also contemplated.

In some implementations, the assembly/connector 20, 30, or portions thereof (e.g. mating interface, plug connector, circuit substrate, and/or cable connector) may include approximately 92 Ohms plus/minus 9 Ohms, or plus/minus 5%, and/or plus/minus 10%.

In some implementations, the assembly/connector 20, 30, or portions thereof (e.g. mating interface, plug connector, circuit substrate, and/or cable connector) may include over approximately 55 dB of IL to XT separation at approximately 25 GHz.

In some implementations, the assembly/connector 20, 30, or portions thereof (e.g. mating interface, plug connector, circuit substrate, and/or cable connector) may include over approximately 40 dB of IL to XT separation at approximately 60 GHz.

In some implementations, the assembly/connector 20, 30, or portions thereof (e.g. mating interface, plug connector, circuit substrate, and/or cable connector) may include 60 GHz of bandwidth.

In some implementations, the assembly/connector 20, 30, or portions thereof (e.g. mating interface, plug connector, circuit substrate, and/or cable connector) may include skewless, edge-coupled connectors (fully symmetrical paths in connector).

In some implementations, the assembly/connector 20, 30, or portions thereof (e.g. mating interface, plug connector, circuit substrate, and/or cable connector) may include cable, mezzanine, and/or card edge connectors.

In some implementations, the assembly/connector 20, 30, or portions thereof (e.g. mating interface, plug connector, circuit substrate, and/or cable connector) may include a single track routing in the die package substrate.

In some implementations, the assembly/connector 20, 30, or portions thereof (e.g. mating interface, plug connector, circuit substrate, and/or cable connector) may include a SMT/BGA/surface mount. In some embodiments, a through hole mounting may be used. Plug connector and cable connector can be separable from each other, such as repeatedly separable and reconnectable. The plug connector can be a vertical connector carried by a major surface of a die package substrate. The vertical connector can be configured to receive the cable connector in a direction perpendicular to the major surface of a die package substrate.

In some implementations, the ASIC may be devoid of screw hole(s) and/or through hole(s).

In some implementations, the one or more connectors may carry at least 64 differential signal pairs per connector. One example is eight rows of electrical conductors with eight differential signal pairs per row. Other examples are four rows of electrical conductors or six rows of electrical conductors. The four-row embodiment can also have eight differential signal pairs per row. The six-row embodiment can also have eight differential signal pairs per row. A two-row embodiment can also have eight differential signal pairs per row. All embodiments can also have more than eight differential signal pairs per row or less eight differential but at least one signal pairs per row. For an approximate 90 mm by approximately 90 mm die package substrate, differential signal pair density can be approximately 320 differential signal pairs, approximately 640 differential signal pairs, approximately 960 differential signal pairs, approximately 1280 differential signal pairs, or more than one differential signal pair and at least approximately 840 differential signal pairs, or more than one differential signal pair and at least approximately 769 differential signal pairs, or some other number of differential signal pairs. Stated another way, at least twenty-eight row, eight differential signal pairs per row connectors can fit around the periphery of approximately 90 mm by approximately 90 mm die package substate. At least thirteen, at least fourteen, at least fifteen, at least sixteen, at least seventeen, at least eighteen, and/or at least nineteen eight row, eight differential signal pairs per row can fit around the periphery of approximately 90 mm by approximately 90 mm die package substrate. A die or keep out region of any die package substrate can be approximately 40 mm by approximately 40 mm. Stated yet another way, at least four or at least five electrical connectors, each with at least eight rows of at least eight differential signal pairs per row can fit along one side of an approximate 90 mm by approximately 90 mm die package substrate. Each electrical connector having eight rows of eight differential signal pairs can have a mating footprint of approximately 13 mm by approximately 13 mm, approximately 13.7 mm by approximately 13.7 mm, approximately 14 mm by approximately 14 mm, approximately 15 mm by approximately 15 mm, etc.

In some embodiments of the invention, for example, an electrical connector may be sized and shaped such that a plurality of the electrical connectors fit on a single side of die package substrate that is no larger than approximately 75 mm by 75 mm to approximately 85 mm to 85 mm, the plurality of electrical connectors collectively carry at least 1024 differential signal pairs, and/or the plurality of electrical connectors transmit approximately 224 Gbps Pam4 signals at approximately 56 GHz to approximately 70 GHz of bandwidth with no more than approximately −40 dB of FEXT (far end crosstalk).

In some embodiments, an electrical connector may be sized and shaped such that a plurality of the electrical connectors fit on a single side of die package substrate that is no larger than approximately 75 mm by 75 mm to approximately 85 mm to 85 mm, the plurality of electrical connectors collectively carry at least 1024 differential signal pairs, and/or the plurality of electrical connectors transmit approximately 224 Gbs Pam4 signals at approximately 56 GHz to approximately 70 GHz of bandwidth with no more than approximately −50 dB of NEXT (near end crosstalk).

In addition, in some embodiments, the plurality of electrical connectors may transmit signals at approximately 60 GHz with no more than approximately −45 dB of FEXT. In various embodiments, the plurality of electrical connectors may transmit signals at approximately 50 GHz with no more than approximately −45 dB of NEXT. In some embodiments, each electrical connector in the plurality of electrical connectors may comprise an egg-crate mating interface. In various embodiments, the electrical connector may be configured to mate with a cable connector.

In some embodiments, an electrical connector may include a mating interface having a plurality of interconnected plates defining a plurality of cavities therein.

In addition, in some embodiments, the connector may include a plurality of cable connectors mated within the plurality of cavities. In various embodiments, each plate of the plurality of plates may include a plurality of slots aligned with a plurality of grooves. In some embodiments, the plurality of plates may define a circumference of a first cavity of the plurality of cavities without any gaps therein. In various embodiments, the plurality of plates may define a row of cavities without any of the plurality of cable connectors. In some embodiments, the plurality of plates may extend for about 90 percent of the length of the cable connector to a substrate. In various embodiments, the electrical connector may include a substrate and a ground contact element positioning the plurality of plates at a distance from the substrate. In some embodiments, the electrical connector may include a die package substrate that is no larger than approximately 75 mm by 75 mm to approximately 85 mm to 85 mm, a plurality of electrical connectors collectively carry at least 1024 differential signal pairs, and/or the plurality of electrical connectors transmit approximately 224 Gbps Pam4 signals at approximately 56 GHz to approximately 70 GHz of bandwidth with no more than approximately −40 dB of FEXT (far end crosstalk) or with no more than approximately −50 dB of NEXT (near end crosstalk). In various embodiments, the plurality of electrical connectors may transmit signals at approximately 60 GHz with no more than approximately −45 dB of FEXT. In some embodiments, the plurality of electrical connectors may transmit signals at approximately 50 GHz with no more than approximately −45 dB of NEXT.

In addition, in some embodiments, an electrical connector configured to be attached to a die package may include at least a density of 256 differential pairs per square inch.

In various embodiments, the electrical connector may transmit approximately 224 Gbps Pam4 signals with no more than approximately −40 dB of crosstalk. In some embodiments, the connector may transmit at approximately 56 GHz to approximately 70 GHz of bandwidth.

In addition, in some embodiments, an electrical connector may include a mating interface. In various embodiments, the connector may include a plug connector having at least one ground contact element configured to mate with the mating interface.

In some embodiments, the ground contact element may include at least one arm mating with the mating interface. In various embodiments, the ground contact element may include at least two arms mating with the mating interface. In some embodiments, the ground contact element may include at least three arms mating with the mating interface. In various embodiments, the ground contact element may include at least four arms mating with the mating interface. In some embodiments, the ground contact element comprises four or more arms mating with the mating interface. In various embodiments, the ground contact element may include at least one solder mass. In some embodiments, the ground contact element may include at least two solder masses immediately adjacent to each other. In various embodiments, the ground contact element comprises at least three solder masses immediately adjacent to each other.

In some embodiments, an electrical connector may include at least one of a mating interface, a plug connector, and/or a cable connector. In various embodiments, the connector may include a 224 Gbps Pam4 signal at 6 ps with 20%-80% rise time.

In some embodiments, the connector may include at least one of FEXT and/or insertion loss. In various embodiments, the FEXT may be under or equal to −30 dB. In some embodiments, the FEXT may be under or equal to −35 dB. In various embodiments, the FEXT may be under or equal to −40 dB. In some embodiments, the FEXT may be under or equal to −45 dB. In various embodiments, the insertion loss may be between 0 dB and −1 dB. In some embodiments, the insertion loss may be between −1 dB and −2 dB. In various embodiments, the insertion loss may be between −2 dB and −3 dB. In some embodiments, the insertion loss may be between −3 dB and −4 dB. In various embodiments, the insertion loss may be between −4 dB and −5 dB. In some embodiments, the connectors may be at 50 GHz, 55 GHz, 60 GHz, 65 GHz, 70 GHz, 75 GHz, and/or 80 GHz.

In various embodiments, the electrical connector may include at least one of NEXT and/or insertion loss. In some embodiments, the NEXT may be under or equal to −40 dB. In various embodiments, the NEXT may be under or equal to −45 dB. In various embodiments, the NEXT may be under or equal to −50 dB. In some embodiments, the NEXT may be under or equal to −55 dB. In various embodiments, the NEXT may be under or equal to −60 dB. In some embodiments, the insertion loss may be between 0 dB and −1 dB. In various embodiments, the insertion loss may be between −1 dB and −2 dB. In some embodiments, the insertion loss may be between −2 dB and −3 dB. In some embodiments, the insertion loss may be between −3 dB and −4 dB. In various embodiments, the insertion loss may be between −4 dB and −5 dB. In some embodiments, the connectors may be at 50 GHz, 55 GHz, 60 GHz, 65 GHz, and/or 70 GHz.

In addition, in some embodiments, an electrical connector may include an outer periphery. In various embodiments, the connector may include a locking mechanism positioned within the outer periphery of the electrical connector.

In some embodiments, the electrical connector may include a mating interface and a plug connector, wherein the locking mechanism may be positioned within an outer periphery of at least one of the mating interface and/or the plug connector. In various embodiments, the locking mechanism may include at least one clip. In some embodiments, the locking mechanism may include at least two clips. In various embodiments, the locking mechanism may include at least one notch. In some embodiments, the locking mechanism may include at least two notches. In various embodiments, the locking mechanism may be positioned within at least one gap between adjacent rows of cavities. In some embodiments, the electrical connector may include a plurality of cable connectors, wherein the locking mechanism may be positioned between adjacent cable connectors of the plurality of cable connectors. In various embodiments, the electrical connector may include a plurality of cavities, wherein the locking mechanism may be positioned between adjacent cavities of the plurality of cavities. In some embodiments, the locking mechanism may be spaced internally away from one or more walls of the outer periphery of the electrical connector. In various embodiments, the connector may be configured to be attached to a die package having at least a density of 256 differential pairs per square inch.

In some embodiments, an electrical connector may include a plurality of differential signal pairs. In various embodiments, the electrical connector may include a plurality of ground contact elements, each configured to receive a respective portion of an egg-crate shield of a mating connector, wherein the electrical connector is devoid of egg-crate crosstalk shielding, is sized and shaped such that a plurality of electrical connectors each respectively fit on a single side of a die package substrate with sides no larger than approximately 75-96 mm each, including approximately 80 mm±5 mm and 91 mm±5 mm, the plurality of electrical connectors collectively carry at least 1024 differential signal pairs, and the plurality of electrical connectors transmit approximately 224 Gbits/sec PAM-4 signals at approximately 56 GHz to approximately 70 GHz of bandwidth with no more than approximately −40 dB of FEXT.

In addition, in some embodiments, the electrical connector further includes a first housing that carries the differential signal pairs and at least two or more of the plurality of ground contacts each define at least two laterally offset, cantilevered beams, wherein each of the at least two laterally offset, cantilevered beams has a respective free end. In various embodiments, the differential signal pairs are surface mounted to the die package substrate. In some embodiments, the differential signal pairs may each comprise first and second stamped and formed electrical conductors. In some embodiments, the electrical connector may further include electrically conductive or electrically non-conductive, magnetic absorbing material or electrically lossy material. In various embodiments, the plurality of differential signal pairs are electrically connected, physically connected, or both to corresponding, respective pads on the die package substrate.

In some embodiments, an electrical connector may include a mating interface having a housing and a plurality of plates defining a plurality of cavities in the housing. In various embodiments, the electrical connector may include at least one retention member retaining at least one of the plurality of plates therebetween and/or the plurality of plates with the housing.

In addition, in some embodiments, at least one retention member may retain the plurality of plates therebetween. In various embodiments, at least one retention member may retain the plurality of plates with the housing. In some embodiments, at least one retention member may retain both the plurality of plates therebetween and the plurality of plates with the housing. In various embodiments, at least one retention member may be an elongated member engaging one or more slots. In some embodiments, at least one retention member may be electrically conductive or electrically non-conductive.

In some embodiments, an electrical connector may include an outer periphery. In various embodiments, the electrical connector may include a locking mechanism positioned in the outer periphery of the electrical connector.

In addition, in some embodiments, the electrical connector may include a mating interface and a plug connector, wherein the locking mechanism may be positioned in an outer periphery of at least one of the mating interface and/or the plug connector. In various embodiments, the locking mechanism may include at least one clip. In some embodiments, the locking mechanism may include at least two clips. In various embodiments, the locking mechanism may include at least one receptacle releasably engaging at least one clip. In some embodiments, the electrical connector may include another locking mechanism positioned within the outer periphery.

In some embodiments, an electrical connector may include a plug connector having a housing. In various embodiments, the electrical connector may include at least one stiffener coupled to the housing.

In addition, in some embodiments, at least one stiffener may be attached to a board side of a die package substrate. In various embodiments, the electrical connector may include at least two of the stiffeners spaced from each other in a horizontal plane. In some embodiments, at least one stiffener may be electrically conductive or electrically non-conductive. In various embodiments, at least one stiffener may include at least one projecting tab.

In addition, in some embodiments, an electrical connector may comprise a means for getting at least 513, at least 600, at least 700, at least 800, at least 900, at least 1000, and/or at least 1024 differential signal pairs off one side of an approximately 75 mm through approximately 95 mm die package substrate that has at least approximately 40 mm square keep out region.

In addition, in some embodiments, an electrical connector may comprise a means for getting at least 513, at least 600, at least 700, at least 800, at least 900, at least 1000, and/or at least 1024 differential signal pairs off one side of a 75 mm through 95 mm die package substrate.

In addition, in some embodiments, an electrical connector may comprise a means for getting at least 513, at least 600, at least 700, at least 800, at least 900, at least 1000, and/or at least 1024 differential signal pairs off one side of any size die package substrate disclosed herein that has at least approximately 40 mm square keep out region.

In addition, in some embodiments, an electrical connector may comprise a means for getting at least 513, at least 600, at least 700, at least 800, at least 900, at least 1000, and/or at least 1024 differential signal pairs off one side of any size die package substrate disclosed herein.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1.-19. (canceled)

20. An electrical connector comprising:
a mating connector having a mating interface, wherein the mating interface includes an egg-crate shield;
a plug connector having a plurality of differential signal pairs and a plurality of ground contact elements, each of the plurality of ground contact elements configured to receive a respective portion of the egg-crate shield of the mating interface; and
wherein the electrical connector is devoid of egg-crate crosstalk shielding, the electrical connector carry at least 64 differential signal pairs, and the electrical connector transmits approximately 224 Gbits/sec PAM-4 signals at approximately 56 GHz to approximately 70 GHz of bandwidth with no more than approximately −40 dB of FEXT.

21. The electrical connector of claim 20 wherein the plurality of ground contact elements comprise at least one arm mating with the mating interface.

22. The electrical connector of claim 20 wherein the plurality of ground contact elements comprise at least two arms mating with the mating interface.

23. The electrical connector of claim 20 wherein the plurality of ground contact elements comprise at least three arms mating with the mating interface.

24. The electrical connector of claim 20 wherein the plurality of ground contact elements comprise at least four arms mating with the mating interface.

25. The electrical connector of claim 20 wherein the plurality of ground contact elements comprise 4 or more arms mating with the mating interface.

26. The electrical connector of claim 20 wherein the plurality of ground contact elements comprise at least one solder mass.

27. The electrical connector of claim 20 wherein the plurality of ground contact elements comprise at least two solder masses immediately adjacent to each other.

28. The electrical connector of claim 20 wherein the plurality of ground contact elements comprise at least three solder masses immediately adjacent to each other.

29. An electrical connector comprising:
a first connector having a mating interface and a plurality of cable connectors, wherein the mating interface includes an egg-crate shield;
a second connector having a plurality of differential signal pairs and a plurality of ground contact elements, each of the plurality of ground contact elements configured to receive a respective portion of the egg-crate shield of the first connector; and
a 224 Gbps Pam4 signal at 6 ps with 20%-80% rise time.

30. The electrical connector of claim 29 further comprising at least one of FEXT and/or insertion loss.

31. The electrical connector of claim 30 wherein the FEXT is under or equal to −30 dB.

32. The electrical connector of claim 30 wherein the FEXT is under or equal to −35 dB.

33. The electrical connector of claim 30 wherein the FEXT is under or equal to −40 dB.

34.-46. (canceled)

47. The electrical connector of claim 29 further comprising at least one of NEXT and/or insertion loss.

48. The electrical connector of claim 47 wherein the NEXT is under or equal to −40 dB.

49. The electrical connector of claim 47 wherein the NEXT is under or equal to −45 dB.

50. The electrical connector of claim 47 wherein the NEXT is under or equal to −50 dB.

51.-73. (canceled)

74. An electrical connector comprising:
a plurality of differential signal pairs; and
a plurality of ground contact elements, each configured to receive a respective portion of an egg-crate shield of a mating connector,
wherein the electrical connector is devoid of egg-crate crosstalk shielding, is sized and shaped such that a plurality of electrical connectors each respectively fit on a single side of a die package substrate with sides no larger than approximately 75-96 mm each, including approximately 80 mm±5 mm and 91 mm±5 mm, the plurality of electrical connectors collectively carry at least 1024 differential signal pairs, and the plurality of electrical connectors transmit approximately 224 Gbits/sec PAM-4 signals at approximately 56 GHz to approximately 70 GHz of bandwidth with no more than approximately −40 dB of FEXT.

75. The electrical connector of claim 74 wherein the electrical connector further comprises a first housing that carries the differential signal pairs and at least two or more of the plurality of ground contacts each define at least two laterally offset, cantilevered beams, wherein each of the at least two laterally offset, cantilevered beams has a respective free end.

76. The electrical connector of claim 74 wherein the differential signal pairs are surface mounted to the die package substrate.

77. The electrical connector of claim 74 wherein the differential signal pairs each comprise first and second stamped and formed electrical conductors.

78. The electrical connector of claim 74 further comprising electrically conductive or electrically non-conductive, magnetic absorbing material or electrically lossy material.

79. The electrical connector of claim 74 wherein the plurality of differential signal pairs are electrically connected, physically connected, or both to corresponding, respective pads on the die package substrate.

80.-83. (canceled)

84. The electrical connector of claim 20 configured to be attached to a die package having at least a density of 256 differential pairs per square inch.

85. The electrical connector of claim 29 configured to be attached to a die package having at least a density of 256 differential pairs per square inch.
